(19) United States
(12) Patent Application Publication
(10) Pub. No.: US 2004/0139396 A1
(43) Pub. Date: Jul. 15, 2004

(54) Stream-based information management system

(76) Inventors: David H. Gelernter, Woodbridge, CT (US); Randy Prager, New York, NY (US); Eric T. Freeman, Bradford, CT (US)

Correspondence Address: Ivan S. Kavrukov, Cooper & Dunham LLP, 1185 Avenue of the Americas, New York, NY, 10036, US

(21) Appl. No.: 10/455,607

(22) Filed: Jun. 4, 2003

Related U.S. Application Data
(63) Continuation of application No. 10/238,367, filed on Sep. 9, 2002.
Application No. 10/238,367 is a continuation-in-part of application No. 10/013,150, filed on Dec. 10, 2001, now Pat. No. 6,725,427.
Application No. 10/238,367 is a continuation-in-part of application No. 09/892,385, filed on Jun. 26, 2001.
Application No. 10/238,367 is a continuation-in-part of application No. 09/892,258, filed on Jun. 26, 2001.
Application No. 10/013,150 is a division of application No. 09/398,611, filed on Sep. 17, 1999, now Pat. No. 6,638,313.
Application No. 09/398,611 is a continuation of application No. 08/673,255, filed on Jun. 28, 1996, now Pat. No. 6,006,227.
(60) Provisional application No. 60/240,480, filed on Oct. 13, 2000.
(60) Provisional application No. 60/274,575, filed on Mar. 9, 2001.
(60) Provisional application No. 60/240,480, filed on Oct. 13, 2000.
(60) Provisional application No. 60/274,575, filed on Mar. 9, 2001.

(51) Int. Cl. G06F 17/21

(52) U.S. Cl. 715/515

(57) ABSTRACT

An enterprise, stream-based system of organizing, storing, retrieving, and displaying information, using top-down or bottom-up topologies or a combination of the two, and providing access to wireless devices that display contracted forms of streams of objects while other end-user devices can display the streams as partly overlapping, receding streams of objects that contain more displayed information. The two types of end-user devices nevertheless use the same or essentially the same methodology in dealing with stream document objects. The system automatically converts diverse kinds of original documents that can come from diverse sources and applications, into stream document objects (SDOs) that conform to a standard format and can be handled the same way in the system, efficiently and consistently in the way people think and look for information.

### REFERENCE TO RELATED APPLICATIONS AND INCORPORATION BY REFERENCE

This patent application is a continuation-in-part of application Ser. No. 10/013,150 filed Dec. 10, 2001, and Ser. Nos. 09/892,385 and 09/892,258 each filed Jun. 26, 2001. In turn: Ser. No. 10/013,150 is a division of Ser. No. 09/398,611 filed Sep. 17, 1999, which is a continuation of Ser. No. 08/673,255 filed Jun. 28, 1996 and now U.S. Pat. No. 6,066,227; and each of Ser. Nos. 09/892,385 and 09/892,258 claims the benefit of provisional application No. 60/240,480 filed Oct. 13, 2000 and 60/274,575 filed Mar. 9, 2001. This patent specification hereby incorporates by reference said prior applications and patent in their entireties, as though fully set forth herein. This patent specification further incorporates by reference the Scopeware User Guide from Mirror World Technologies, Inc. of New Haven, Conn., submitted with an IDS concurrently with the filing this patent application.

### INCORPORATION BY REFERENCE OF MATERIAL ON COMPACT DISC

This patent specification incorporates by reference the contents of the compact disc (CD-ROM) attached hereto in duplicate (Copy 1 and Copy 2), containing an object code program that is an example of an implementation of preferred embodiments described in this patent specification. Each disc is labeled in accordance with Rule 1.53(e)(6), with the collective names Scopeware 2.2. The date of creation of the files on the disc is Aug. 9, 2002. The computer code on the compact disc was generated from correspondingly named source code. The names of individual files on the disc within these collective names, as well as the size of the individual files, are identified in the list of files attached to the Transmission Letter In Accordance with 37 C.F.R. § 1.52(e)(ii). The contents of the compact disc submitted herewith in duplicate and the contents of the list of files attached to said Transmission Letter are hereby incorporated by reference in this application as though fully set forth herein.

### FIELD

This patent specification is in the field of information storage and retrieval, and specifically relates to an enhanced system and process that automatically capture, manage, and safeguard information in a way that enables users to conveniently share, discover, and act through an intuitive interface.

### BACKGROUND AND SUMMARY

A desktop metaphor, involving hierarchical systems of directories, files, folders and icons that people use to manage information on office or home computers, is decades old and increasingly unable to meet today's needs. When using computers with vastly more storage than those for which the desktop metaphor was designed, and a vastly greater number and variety of stored information, the burden of remembering the name of a file or the folder in which it was put, is simply too great for effective use of the information that should in theory be available but in reality may not be because it is too hard to find.

Separate electronic documents—files and emails, calendar and address book entries, scans, bookmarks, spreadsheets, photos, etc.—may contain all the information the user needs, but it is scattered in folders, on desktops, in mailers and browsers and other special applications, on the office computer, the home computer, the other home computers, the server, the laptop, the palmtop, etc. The information is all there, but not necessarily when and where needed, or in the appropriate form. A picture on a computer screen is made up of separate pixels, arranged in a certain way. But, take the same pixels and mix them up at random, or organize them cleverly into pixel folders so all the red pixels are together on the left side of the screen, and all the green pixel are neatly on the right, and there is no picture. The information may all be there, perhaps each pixel in the folders will be stored together with the x-y coordinates it had in the picture, so they can be reshuffled back to their places eventually, but the user no longer sees a picture. The information that the picture conveyed no longer comes from looking at the screen. In the right order on the screen, the pixels are a picture; in the wrong order, they are not information that the user perceives.

There is a natural way to arrange pixels in a screen image, characters in a word, words in a speech or in a book, There also is a natural way to arrange a collection of electronic documents—in time order, in a narrative order, in a way that mirrors life and experience. In a natural order, there is a story, a narrative: the pixels are arranged to show a picture, the words make sense, and the electronic documents tell a story. If the documents are scattered so some are in drive C and some in drive D, some in folder A and some in folder B or on a desktop, in a mailer or browser, some on PCs, some on wireless platforms, then it looks like information but lacks context, something critical is missing.

Real-life computerized information needs to be continuous, heterogeneous, and dynamic. An organization creates and receives information all the time, as an ongoing event, continuously. The information is heterogeneous—word processing files, emails, spreadsheets, and many other kinds of documents. If someone needs to know about the process that led to a sale, she needs to see many different kinds of information, arranged in the right order: the initial emails or contact reports, followed by internal discussion notes, a first meeting date, reports on the meeting, contact information, more emails, maybe another meeting, purchase orders, invoices . . . . Before computers all documents dealing with a sale may have been in a single cardboard folder, but in desktop metaphor days emails are in an email folder, photos go in a different folder, purchase orders in a third folder, so none of these folders by itself tells the story. In the desktop metaphor of systems such as Windows, text files are stored one way, email another way, contacts yet another way, other types on information in yet other ways, the file structure can be unmanageable for many people, and a search in contacts may not reach information in email that could be just as important. That is increasingly unsuitable for real-life information.

Real-life information is dynamic because the information world keeps changing. New information arrives or is created: new emails and memos, bookmarks, calender updates, scans, news reports. The user should be able to see real-life information in context, arranged in a way that makes it useful and gives it meaning. The user should be able to access the information structure from any device he uses, through a wired or a wireless connection. The same information structure should be accessible from all devices.

A stream, as used in the system disclosed here, is a natural way to organize information that is continuous, heterogeneous, and dynamic. For an organization, a stream is the history of the ordinary, day-by-day business experience, in the form of a narrative stream of documents—all of the electronic documents that tell what the organization is doing, moment by moment, the contacts it is making, meetings it is planning, projects it is working on, topics it is discussing, transactions being made—all configured into a single narrative stream. It is a virtual stream of information that lives in cyberspace. Anyone with access permission can tune in from anywhere. A user can tune in from her desktop PC, from a laptop, a palmtop, a cell phone, or any other device with access. The stream looks like a parade of documents, all sorts of documents in one parade. In principle the parade begins when the company is born, continues until now, and then stretches into the future, as plans for the future also are information and also are part of the organization's story. Public and private documents are in the stream; naturally, private documents are visible only to their owners, group documents are visible to the respective group, and public documents can be visible to everyone. All of the organization's structured and unstructured information can go into the stream and tell the organization's story.

Each new documents appears at the head of the stream automatically; the stream grown constantly. A user can tune in and watch it grow, but would see only the part of the stream she is entitled to see. The whole stream is there and each user sees a piece of it. Each new piece of contact information, message, memo, email, file, proposal, bookmark, scanned image, and so on appears automatically at the head of the stream. If a user is about to call Bob Schwartz and ask a question, it might be useful to know that someone else has called and asked a similar question a year ago, and that someone called with a similar question two years ago, and that Schwartz wrote to the organization three years ago complaining about something. This information may all be public within the organization, and the user may be entitled to know it, and might need to know it, but that does not mean she is going to know it unless she has the right knowledge management software. But if all information is in a stream, the organization's life story is there, in one stream, and all the user has to do is search on Bob Schwartz—type his name in the search box and hit return. This gets a new stream. The old one represented the whole organization's story, all of the history the user was entitled to see, growing constantly. The new stream is a substream that has the same shape and structure as the old one, it is also chronological, a narrative, but it is a Bob Schwartz stream. All the information about the organization's dealings with Bob Schwartz is in the new stream: the letters, the email, the call reports—the documentary story of the organization's dealings with Bob Schwartz that the user may want to know about before making the call.

The user may do it through a desktop PC, from a cell phone, or any other device that can connect to the original stream. What the stream actually looks like onscreen depends on the device. Adjustments can be made for the smaller screen and different controls of a wireless device but the wireless device still puts the user into the same information world of the same stream. Only one informational structure is there for any device the user picks to access it. The question “where did I put that piece of information” has one answer all the time—it is in the stream, period. Structured and unstructured information is in one place, in the stream. It need not be stuck it the separate pigeonholes the desktop metaphor imposes.

On a desktop, or any device with a big enough screen, the stream may look like a receding parade of documents, or index cards. A new document appears in front, at the head of the stream, and everything else takes a step back. The stream flows as new elements join. When a user tunes in the stream with a small-screen device, a palmtop or a cell phone for example, a simple list may take the place of the receding parade, or some other abbreviation may show up. When the user points to an element in the streamview, he gets a summary overview of the document instantaneously, and can flip through all the information online in more or less the same way as through the pages of a magazine.

Ordinarily the user views the stream from the “now” line, looking from the present into the past. Further-away documents are older. The furthest away is the oldest. But the stream has a future as well as a past. For a meeting scheduled for 2 PM tomorrow, the user puts a note in the stream future. The calendar note flows steadily toward “now.” When it reaches it, it appears at the “now” point, at the head of the stream, and then flows steadily back into the past, along with everything else. The stream is thus a calendar and reminder system, it is a real-time news system about what is happening now, and it is a complete archive, a time-ordered story of the past.

How does the user find information from the stream? By using search, browse, and time-order. The symbiosis of these three can make them worth more in the stream world. A search returns another stream, a substream, that looks and behaves just like the original stream but is focused on one topic. The user can search on any word and phrase—as every word in every document in the stream is automatically indexed—on documents and meta-data, and on time-related data. If she searches the stream on “Zeppelin”—that is, she sees the regular stream onscreen and then types “Zeppelin” in the search box—everything that does not mention Zeppelin disappears and the screen shows a new stream just like the old one—looks the same, works the same (with search and browse), also has a past, present and future, but everything in it mentions Zeppelin. It is a Zeppelin stream.

A stream vacuums up information automatically, drops it into the narrative, at the right point, and right format, automatically. It matters not who generated the information, what machine it came from, what name it has (or that no one gave it a name), what folder or desktop it was dropped in, what application it came from, what type it is. It all goes into one unified stream.

This is how a stream works with an everyday business problem. Suppose an irate customer is on the phone. Some customer had bought a big lot of high-end printers. Now they are not working right. The sale was three years ago. The salesman who sold the printers has left the company. Nothing unusual about that so far. The company CEO has to figure out what to do. Who was responsible? How to react? You can not ask the salesman—he is gone and the deal was three years ago and he could have easily forgotten the details. Could the CEO simply rewind history and go back to the time of the original sale? With a stream, yes. Looking at the stream and doing a search in a few seconds on that sale, the CEO has before him the story of the sale—the original sales call, the customer specifications, email dialogues, the proposal, customer feedbacks on budget constraints, revised proposals suggesting lower-end printers initially to meet the budget but with the plan to upgrade later. So, the situation can be diffused, with an angry customer turned into an informed customer who understands what had gone on and why the printers need an upgrade to meet current needs. This was not a matter of one document, the point was not to find a single document that told the whole story, or even a batch of documents that would be stored in the same place in a traditional system. The story was in the sequence, and in the stream. Nothing unusual or exotic about this case. Companies do business and need to find out what they did, even if people leave, even if people forget, even if people remember wrong. The company still needs the information that tells what happened.

The stream need not be installed on local machines; users can tune it in by using a browser or some other means so the stream can be anywhere. It can be stored in a secure location, or at multiple locations. One or a few locations can store the complete documents while others store less complete versions but are able to find the complete versions.

How can a stream-based approach be a part of a strategy to enable any organizational unit, from a single end-user and a single computing device to hundreds to millions of end-users and hundreds to millions of computing devices, organize information into streams?

In general streams are ordered informational stacks, organized by time, relevance, topic, or other descriptor. Information of any type can be included in the stream by wrapping the information in a standard stream document object model.

The stream document object model is a standard framework, or meta-document wrapper, that can allow objects of vastly different characteristics to appear similar and behave in the same or similar fashion. Using a stream document object model we can incorporate static and real-time information—an email (static) and a live video feed from a TV channel (real-time). Using a stream document object model we can incorporate information of different applications—a Word document, a Powerpoint presentation, a spreadsheet, an email. Using a stream document object model we can incorporate information of different modalities—a text file, a video file, an audio file, a picture, etc. Any type of digital information can be “wrapped” inside of the stream document object model. Any information so wrapped can then become an object in the stream itself.

Streams are ideal for organizing and managing vast amounts of information from distributed locations and of different type due to the visual presentation and the stream document object model. The software application process can take a number of forms depending on its service role in the network. Any one of several morphological variants of software applications can be used, operating across hardware platforms, operating systems and kernels, using at least one software application but also capable of using numerous software applications operating in concert. Two main types of software applications are:

a) Client Application—a software application that is designed to operate at or close to an end-user, typically on an end-user or employee computing device such as a desktop, laptop, mobile device such as a cell phone or PDA, a set-top box, or some other device. Typically a client application operates for a single user or a small community of users; and

b) Server Application—a software application that is designed to operate for numerous end-users and other software applications. Server applications typically operate at locations convenient for communities of users to access the server application, and typically run on one or more servers.

Using these basic definitions we describe examples of methods of using client applications and server applications to enable a vast network of end-users and computing resources to co-operate to deliver organized streams of information.

One approach involves a Top Down Topology (clients and servers). In this model, server applications have a number of core roles, including:

a) Member registry, address and lookup. Each server acts as a directory of other server applications, client applications, users, and enterprise resources such as mail servers, CRM, ERP platforms etc.;

b) Stream document object routers that are responsible for collecting, sending and storing stream document objects to other server applications, client applications and other enterprise resources like CRM and ERP systems; and

c) Stream document object presentation and interaction, responsible for display and action upon streams of stream document objects.

In the same model, client applications have a number of core roles, including:

a) Stream document object routers that are responsible for collecting, sending and storing stream document objects to server applications (and, through them, to other client applications); and

b) Stream document object presentation and interaction, responsible for display and action upon streams of stream document objects.

For example, suppose we have a number of client applications and a number of server applications working together to deliver information within an organization as streams of stream document objects. Client application A (called Client A) collects information from the local end-user computing platform of user A. The information can be of any type. Client application A automatically wraps the information in the stream document object model, transforming the information into a stream document object. User A can then use client application A to manage information on the local computing device in streams of stream document objects.

Client application A can connect programmatically to a server application A at Server A. The mechanics of the connection can be through traditional methods like IP address, DNS registry, etc. Server A can communicate, manage and understand information including stream document objects. Server A can communicate with any system using standard protocols and formats including EDI, XML, and custom protocols, and retrieve information result sets and wrap those result sets with the stream document object model. Server A can then transform information in other systems like CRM, ERP, email, etc. into stream document objects. Server A also collects information from the computing platforms. The information can be of any type. Server A wraps the information in the stream document object model, transforming the information into a stream document object (SDO).

Server A also has a number of other connections to other resources such as Server B, Server C and Server D, each running its server application. Server A knows of enterprise resources through a number of mechanisms including IP address, DNS registry, etc. These enterprise resources include server applications and client applications of a variety of types including ERP systems, CRM system, printing systems, etc. Connected to Server B is a client application B (Client B) used by user B. Client B can communicate, manage and understand information including stream document objects. Connected to Server C is a client application C (Client C). Client C can communicate, manage and understand information including stream document objects. Connected to Server D is a client application D (Client D). Client D can communicate, manage and understand information including stream document objects.

We now have a basic topology of Server applications and Client applications. The goal of this topology is to organize all information into streams of stream document objects.

For example, User A wants to send Stream Document Object 1 (SDO1) to every resource in the entire organization. Using this particular topology, SDO1 is sent to server application at Server A, i.e., the server that serves Client A. A copy of SDO1 exists now on Server A. Server A sends SDO1 to known resources, the server applications at Server B, Server C and Server D. Server B in turn sends a copy of SDO1 to every client application it serves, e.g. Client B. Server C sends a copy of SDO1 to every client application it serves, e.g. Client C. Server D sends a copy of SDO1 to every client application it serves, e.g. Client D.

SDO1, originally from Client A, now exists on Server B, Server C, Server D, Client B, Client C and Client D. This is important since connections between all enterprise resources may be, or may become, unavailable at any time. When connections are available SDO1 is transferred to the client applications or server applications.

As new clients connect to servers, say Client B1 connects to Server B, SDO1 can be sent to Client B1. As new servers connect, say Server E connects to Server D, SDO1 can be sent to Server E (and then Server E can send SDO1 to a Client E). Should Client B disconnect entirely from the topology all stream document objects like SDO1 sent to it via the topology before disconnection are available at Client B, and any subsequent SDOs that should have been sent to it are available to it upon re-connection.

Servers B-E and Clients B-E may have SDOs that will not be sent as SDO1 was above, e.g. they may be sent or stored in different ways, but we can still use this topology to manage information of any type into streams of SDOs. SDOs may live forever or for a period of time solely on a client application or on a server application.

User E (served by server E that can connect to servers A-D) searches for information throughout the entire organization. Clients A-D, and Servers A-E can all respond with particular SDOs. These can be sent to Client E through Server E. When User E searches for information throughout the organization, SDOs are returned from connected applications like Server E. Server E itself connects to enterprise resources like Server A-D and can return SDOs to User E's Client E through Server E. This information in the organization can be organized and managed as SDOs through a network of clients and servers. Servers A-E can wrap information from other enterprise systems like ERP, CRM, email into SDOs and return these through Server E to User E's Client E.

These SDOs may or may not include the original information; they may be simply the stream document object wrappers, or some other subset or description of the original information. Since each client application or server application understands and communicates SDOs, sets of SDOs from every source can be organized by Client E into at least one stream of SDOs for User E.

Further, User E can also use only Server E to search the topology if no local computing device was available to run client application E. This is similar to using a web browser to communicate to Server E.

A variation of this topology includes no client applications like Clients A-E. In this variation all information is wrapped into SDOs by Servers A-E and users connect directly to Servers A-E, typically through a web browser or other thin client application.

In top-down topology, the server applications are responsible for distributing the stream document objects to other servers and to client applications. While a client application may designate where the SDOs should go, it is the server application(s) that are in charge of distributing them to the appropriate client applications for use by the respective end-users.

Another topology model is a Bottom Up Topology, in which one or more server applications are responsible for enabling the client applications to distribute SDOs but the client applications are responsible for actually distributing them to other client applications, either directly or through the server applications. For example, a client application may obtain from a server application information such as which client applications are accessible and how to access them, but the client application retains the ultimate responsibility for actually distributing SDOs to other client applications or to server applications In the bottom-up model, server applications similarly have a number of core roles, including:

a) Member registry, address and lookup. Each server acts as a directory of other server applications, client applications, users, and enterprise resources such as mail servers, CRM, ERP platforms etc.;

b) Stream document object routers that are responsible for collecting, sending and storing stream document objects to other server applications, client applications and other enterprise resources like CRM and ERP systems; and

c) Stream document object presentation and interaction, responsible for display and action upon streams of stream document objects.

In the bottom up model client applications similarly have a number of core roles, including:

a) Stream document object routers, responsible for collecting, sending and storing stream document objects to other client applications or to server applications; and

b) Stream document object presentation and interaction, responsible for display and action upon streams of stream document objects.

For example, suppose we have a number of client applications and a number of server applications working together to deliver information within an organization as streams of stream document objects. Client A collects information from the local end-user computing platform. The information can be of any type. Client A wraps the information in the stream document object model, transforming the information into a stream document object. User A can then use the client application A (Client A) to manage information on the local computing device in streams of stream document objects.

Client A can connect programmatically to server application A at Server A that serves Client A. The mechanics of the connection can be through traditional methods like IP address, DNS registry, etc. Server A can communicate, manage and understand information including stream document objects. Server A can communicate with any system using standard protocols and formats including EDI, XML, custom protocols and retrieve information result sets and wrap those result sets with the stream document object model. Server A can then transform information in other systems like CRM, ERP, email, etc. into stream document objects. Server A also collects information from the computing platforms. The information can be of any type. Server A wraps the information in the stream document object model transforming the information into a stream document object.

Server A also has a number of other connections to other stream server resources, e.g. Server B. Server A knows of enterprise resources through a number of mechanisms including IP address, DNS registry, etc. These enterprise resources include server and client applications of a variety of types including ERP systems, CRM system, printing systems, etc. Connected to Server B is a client application B (Client B). Client B can communicate, manage and understand information including stream document objects.

In this model, User A and User B can form working groups by connecting Client A directly to Client B. Server A and Server B can assist this connection. Client A connects to Server A, Client B connects to Server B and Server A and Server B share information about the location of their connected client applications Client A and Client B. Client A and Client B can connect in other ways as well, including by having User A and User B configure their applications directly.

As in Top Down topology, connections between systems are transitory, meaning Server A, Server B, Client A and Client B may be disconnected at any time. Thus in this model Client A can send specific SDOs to Server A so that they will be available to other resources, like Server B, even if Client A is disconnected. Server A and Server B become SDO storage platforms for important information. The Client a SDO sent to Server A can be routed to Server B as well by Server A.

Client A can send to Client B all of A's SDOs or a subset of A's SDOs. These can be sent directly to Client B and need not need to pass through Server A or Server B. When User B searches for information throughout the organization, SDOs are returned from connected client applications like Client A and connected server applications like Server B. Server B itself connects to enterprise resources like Server A and can return SDOs to User B's Client B through Server B. This information in the organization can be organized and managed as SDOs through a network of clients and servers.

These SDOs may or may not include the original information. Again, they can be simply the stream document object wrappers, or some other subset or description of the information. Since each client application or server application understands and communicates SDOs, sets of SDOs from every source can be organized by Client B into at least one stream of SDOs for User B.

User B could also use only Server B to search the topology if no local computing device was available to run client application B. This is similar to using a web browser to communicate to Server B. Any SDOs not specifically sent to Server B by Client B need not be available.

A variation of this topology includes no servers. In this variation users connect their client applications directly and search and route SDOs directly, e.g., User A connects to User B without necessarily going through Server B or Server A. This is a peer-to-peer topology.

In each topology, the system handles all types of different documents, or items of information, in essentially the same way, even if the document is of a type or format unknown to the system. Each document when created, received or otherwise encountered is treated consistently, after conversion to a stream document object (SDO) conforming to a standard document object model. As described below in more detail, the system processes the original documents to create SDOs enriched with various aids that can include significant information about the document such as summary, type of document, thumbnail of the document, who is the document's owner, who has permission to access the document, keywords, command options, time stamp, index, etc. This creation of or conversion to SDOs is done automatically, although the user can aid the process. It can be done by a translator agent or programmatically.

The terms “document” and information asset (IA) are used here can mean the complete document that is supplied to the system or is created within the system, or any one of a number of different formats or representations of such documents of IAs depending on the origin of the documents or IAs and how they are transmitted, created, or processed for use in the system. Such document of IA representation may be further characterized by more specific terms, such as stream document object (SDO), browse card, index card, glance view, etc. A “stream document object” (SDO) refers to a document that includes a meta-wrapper combined with the original document of IA to enable the system to carry out its operations despite the fact that the original documents of IAs may have been in diverse formats and may have come from diverse sources and be in different modalities. The term “standard document object” is sometimes used interchangeably with “stream document object.”

The disclosed system automatically creates the stream document objects (SDOs) for the respective original documents that the system receives or creates. As a result, the SDOs of heterogeneous documents can be in the same format and processed accordingly, without complications due to the fact that the original documents may have been in very different formats and may have come from very different applications. The SDO-based document representations can contain items such as Glyphs that tell at a glance the document type (e.g., a Word file, email, etc.), Thumbnail graphics that tell more about the type of document (e.g., memo, audio file, etc.), and other notation such as, without limitation, title, summary, headers, options, command buttons, etc.

Document representations based on the SDOs can be displayed to the user in a number of ways. One way to represent original documents based on their SDOs is to create document representations called browse cards or index cards that contain information derived from the original documents and typically are smaller in size than the original documents. These browse or index cards can be displayed to the user in a number of ways. A common and particularly efficient way is to display then in a receding, partly overlapping stack, in time order as earlier discussed. When a cursor on the display touches a browse card, a glance view of the document appears at a different part of the screen. The glance view can be simply the browse card of the same original document, but completely visible at a separate part of the display rather than partly overlaid by other browse card, or it can contain more information or less information. One important difference from traditional systems is that the glance view can show command buttons that match the type of documents. While the command set for traditional systems may use the same command button set for different types of documents, in the disclosed system the command set that shows in the glance view is specific to the document—it has the unique combination of command buttons that make sense for that document. The command buttons unique to the glance view can be shown on the glance view itself or separately. As noted, the glance view comes on the screen automatically when the cursor simply touches the corresponding browse or index card in the displayed stream; the user need not take any other action such as clicking on the document represented (browse card) in the stream or taking an action that calls a program to open or work with the document.

Other views can be used as alternatives to the stream view. For example, the display can be in the form of a list view that displays SDO-based information in list form, with a portion of the information visible so the user can quickly identify the document's contents without opening it. A calender view enables the document representations to be based on the month, day, and time they were entered into the system. An address book display can be arranged by contact or by sets of contacts. A grid view display can show the SDO-based document representations as a non-overlapping group, and may be particularly suited to SDO-based browse cards of images. In a Q-view, one part of the screen shows a list of documents while another shows a glance view of the document whose title the cursor currently touches.

The universal SDO of a document is created as a new document of any type is added to the basic stream of information items. It is done for any existing, legacy documents, when the system is installed, and is done automatically as any additional documents are created or otherwise come in Metadata such as owner, date, access permission and keywords are created as part of this automatic process.

Access permission is a part of a document's metadata, unique to that document, so permission levels need not have the constraints of traditional information handling systems where a group or an individual typically has access to all documents in a particular folder or directory, or has a particular type of access to a folder.

Search results are integrated into a substream, at the right place, when and as they become available. The user can start using an incomplete substream and watch it build up. If the search must extend over a number of computers or even servers, and some are unavailable at the time, the results that come in when any become available are integrated into the substream at the right places.

The SDOs discussed here can overcome unique and difficult issues that arise when wireless devices such as cell phones and personal digital assistants (e.g., a PDA such as a Palm Pilot) request information from remote databases or need to process such information to a significant extent. Various limitations of such devices, such as in one or more of bandwidth, screen size, input/output capability, limited memory, etc., can distinguish them from personal computers and make it difficult to effectively deal with such databases and with remote processors. Wireless devices of this type may be hard to navigate, may require painstaking typing or other ways of entering information, and may not present information efficiently on their typically smaller screens. With an SDO-based system as described here, a wireless device can receive and handle document representations that are contracted in a manner unique both to the nature of the respective documents and to limitations of the wireless device. For example, if the document is a long memo, a source such as a server operating in accordance with the disclosed system can initially transmit only a summary and perhaps some identifying information such as who created the document and when. If the request is for several documents, the server can initially transmit only some identifying information for each of the documents. If the documents are too many for the purpose, the server can transmit for display a rolling window of identifying information so the wireless device user can scroll through the few items the screen can show at one time. Further, if the wireless device is a PDA with a larger screen, the server can transmit for display more information than if the device is a cell phone with a smaller screen. In addition to transmitting the truncated document(s), the server can transmit to the wireless device a set of one or more associated commands unique to the nature of the requested document(s). For example, if the document is an email, the command set can be “reply” and “forward,” whereas if the document is a memo, the command set can include an “edit” command, and if the document is search results the command set can include a “refine search” command. The commands can be displayed as operations buttons at the wireless device. Still further, the commands can be geared to the nature of the wireless device as well. For example, the command set can be richer for a PDA than for a cell phone.

When the user enters one of the displayed commands at the wireless device, for example by tapping on a command button, the server can respond by taking corresponding action and wirelessly sending additional information to the device in accordance with said action. For example, if the command is to forward an email to another recipient, the server (and not the wireless device) can carry out the requested action. If the command is for additional information from the requested document(s), the server can do any appropriate operations thereon and transmit the results to the wireless device. If the command is for a refined search, the server can carry it out and transmit the results to the wireless device. Again, these operations at the server, and particularly the information transmitted to the wireless device, are geared to both the nature of the information and to limitations of the device such as in bandwidth, display and input/output capabilities, although client side applications can also carry out processing. An important feature is that the wireless device need not store the database, and could but need not have special software or extensive processing capabilities—it only need to use a native browser and the processing, display and wireless access capabilities that it already has. Another device, such as a server operating in accordance with the system disclosed here can do the bulk of the work in a manner unique to the needs of the particular wireless device. The server and its software can automatically create summaries of dozens or even hundreds of file types, specially formatted for the screen capabilities of wireless devices, create complete emails (and attachments), events, memos, and other documents, search local storage or entire networks for the information the wireless device needs and act on it, and forward information, replies and security levels of protection as needed.

Thus, the stream display modes can both expand and contract, to suit a particular user or a particular display device. If the user is on a PC with a large screen, the display mode may include the receding stack of partly overlapping SDOs, with glance views shown on the side. If the user is on a smaller screen, or prefers a different format, the display can be in calendar form or as Q-list. If the same use is on a wireless device with a small screen, the stream display can be further contracted to suit. Similarly, if a voice interface is used instead of, or in addition to an interface with a display for the user, the user can be presented with a contracted version of the stream as speech that can be computer-generated by know text-to-speech software or otherwise. In addition, a voice interface with known speech-to-text capabilities can be used to translate voice commands or other input from the user in interacting with the stream-based system.

Other aspects and embodiments are described below, including wireless embodiments.

### BRIEF DESCRIPTION OF THE DRAWINGS

FIG. 1 illustrates a screen that can serve as a default view when a software product according to a preferred embodiment is opened on a computer; the labels that are added are not normally a part of the displayed screen.

FIGS. 2-8 are flowcharts illustrating processes in an example of a preferred embodiment.

FIGS. 9 and 10 are examples of system topologies.

FIGS. 11-18 illustrate screens used in explaining an implementation involving a personal digital assistant (PDA) wireless device.

FIG. 19 illustrates a WAP-capable cell phone used in another implementation.

FIGS. 20-29 illustrate cell phone screens.

FIG. 30 illustrates two types of PDA devices and one type of cell phone, with relevant screen displays.

### DETAILED DESCRIPTION

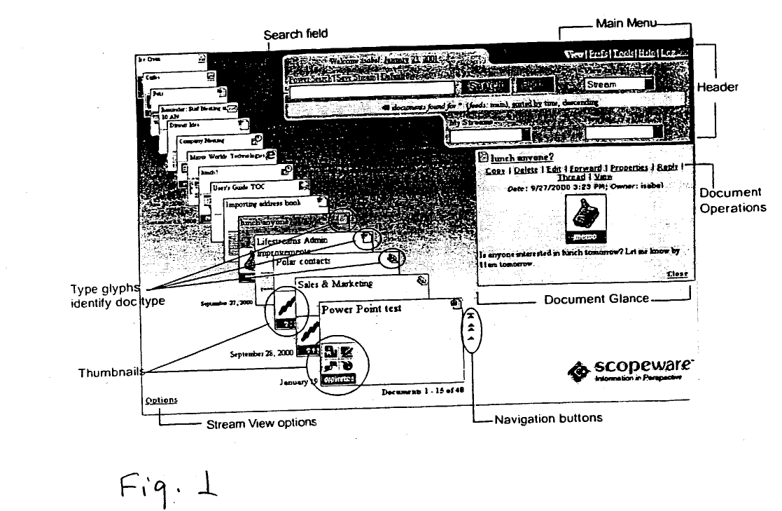

FIG. 1—Stream View Display:

FIG. 1 illustrates a stream view screen seen on a PC or some other device that has a sufficiently large display and works as a part of an example of the disclosed system. It can show up upon turning on the computer or some other device, or upon calling the disclosed system. As seen in FIG. 1, the screen illustrates a receding stream of document representations, which for the purposes of this discussion can be called simply documents, with the most recent document in front. The document representations in the displayed receding stack can also be called browse cards or index cards. Passing the cursor over a document in the stream causes that document's “glance view” to appear on the screen essentially instantaneously. The glance view of a document is so labeled in FIG. 1. The screen also includes the following features appropriately labeled in FIG. 1: (a) the Search Field is an area in which the user can type one or more words for which the system will search in documents (also called standard document objects or information assets and abbreviated to SDO and IA) in the displayed part of the stream and/or in additional SDOs and IAs that are in the same stream but might not be displayed because the stream is too large to show on a single screen; (b) the Main Menu is where the user sets preferences, finds help information, logs out, and/or performs other operations; (c) the Header contains information such as links, command buttons and choice boxes used to navigate; (d) the Stream View Options allow the user to configure the presentation of the stream of information assets; (e) the Document Glance allows quick scanning of SDOs or IAs that are visible on the screen, and presentation of more detailed information on the selected information asset; (f) the Type Glyphs identify the nature of an SDO or IA at a glance (e.g., that it is a Word document); and (g) the Thumbnails is a graphic representation of the type of document (e.g., an audio file, an email, an event, etc.). The User Guide published by the assignee hereof (submitted concurrently with the filing of this application with an IDS form) further describes the operation of a relevant example and, together with the programs contained in the compact disc submitted herewith, provides a more detailed disclosure of examples of preferred embodiments and are hereby incorporated by reference in this patent specification.

Certain particularly novel features of the disclosed system are described below by reference to flowcharts and block diagrams. More detailed information on a particular example of implementation of these and other features of the system are evident from the software on the attached compact disc, which is the best mode known to the inventors at the time of filing this patent application, although persons of the appropriate level of skill in this technology can create alternate versions based on the text and figures of this patent specification without undue experimentation.

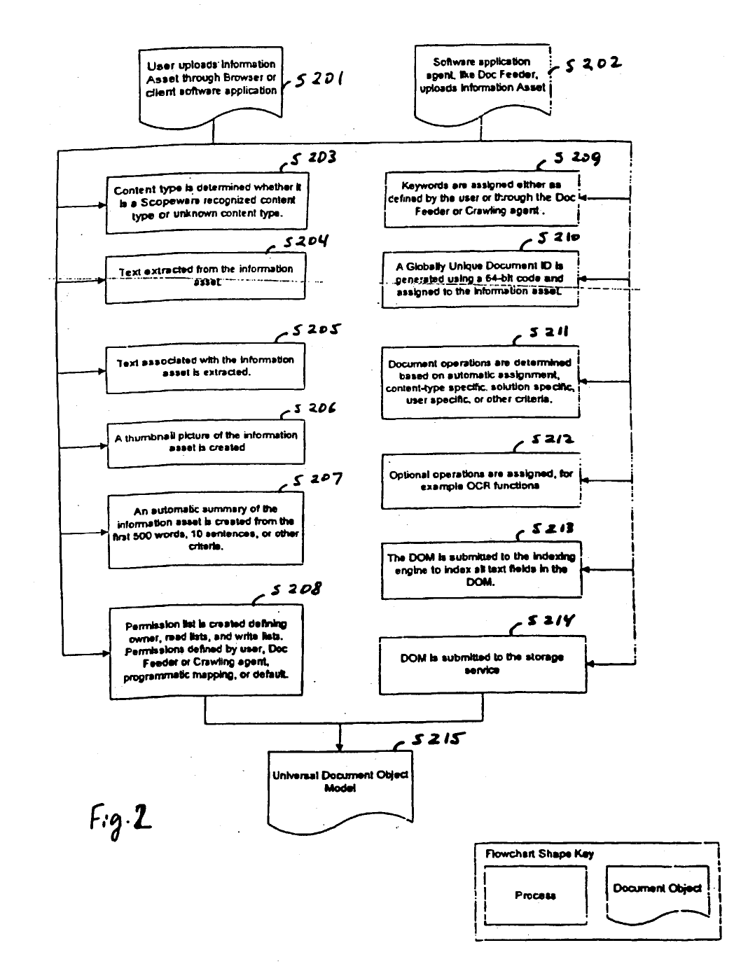

FIGS. 2-4—Universal or Standard Data Object Model (SDO):

FIG. 2 illustrates creation of a universal or standard data object model (SDO) of a document in accordance with a preferred embodiment. This is an important operation that helps bring about efficient handling of heterogeneous document types in a manner that users find particularly easy and intuitive. A standard document object model (SDO) can be thought of as a document shell or wrapper of the underlying full document or information asset that contains, among other items, a thumbnail of the information asset, permission rights, and metadata providing additional information. The SDO is automatically created from the original document or information asset and is stored in a desktop computer or some other user's device and/or a server, either independently of the original document or information asset itself or with a replica (copy) thereof. From there, the system makes available the SDO (with a pointer to its original document or information asset) to the desktop user or to users that have access to the document through some connection, wired or wireless directly or through a server.

As seen in FIG. 2, the process of creating SDOs starts with the uploading at step S201 of information assets (documents) through a browser or a client application or a server application, or at step S202 with uploading using a software application agent called Doc Feeder in some embodiments of the disclosed system. At the following steps, which need not be performed in the order of their description below, an SDO of the IA is created. The IA uploaded at step S201 or S202 can comprise structured or unstructured data. At step S203 the process determines the content type of the IA, e.g., if it is a type that the system recognizes. If it is, the system includes content-type specific metadata in the document's SDO: MIME/content type information, a glyph of the application that creates/views the content-type, and/or the system assigns other content-type data to the SDO shell. If step S203 determines that the IA is an unknown content type, it assigns to the SDO a content-type for “unknown content-type.”. Step S204 extracts text from the information asset, for example, in a text document, this step extracts the text of the document. Step S205 extracts text that may not be within but may be associated with the information asset, for example, the time stamp of the document, the owner of the document, and possibly other textual information that is or can be associated with the document. Other possible examples are attributes of the IA such as file reference path, database/repository path, file metrics such as size, encryption, other identification information, etc. Step S206 generates a thumbnail picture of the IA. The thumbnail can be a reduced-size picture of the document, for example of the first page, and can be converted to a graphic image format. Other examples of thumbnails are JPEG, MPEG, BMP, GIF, AVI, or other still or moving image files representative of some aspect of the IA. Step S207 produces an automatic summary of the IA, e.g., a replica of its first 500 words, or first 10 sentences, or some other information copied or otherwise derived from the IA. Step S208 creates a permission list unique to the IA that defines the owner of the IA (e.g., its creator), and lists of people or entities and groups that can access the IA or the SDO of that IA for reading and/or writing purposes. This permission list can be defined by the user for the particular IA or for a class of IAs, or can be created automatically, e.g., by software agents called Doc Feeder or Crawling agent in a particular embodiment of the described system, or by programmatic mapping such as LDAP, Active Directory, NTDS or some other mapping. Alternatively, at least for some documents, the permission list can be a default setting.

Step S209 assigns keywords to the information asset. The software agents Doc Feeder or Crawler can assign keywords, and the user can manually assign or add keywords. Step S210 generates and assigns to the IA a Globally Unique Document ID, e.g. as 64 bit code unique to the IA. Step S211 determines and assigns to the IA document operations that are unique to the IA. Depending on the IA, these operations or command buttons can be basic, such as “View” and “Reply.” They can be content-specific, such as “Play” for multimedia information assets. They can be solution-specific, such as “Fax” for a message or some other document suitable for faxing, or “Purchase” for an order form. They can be user-specific, such as “Delete” allowed to only certain users. An important point is that the operations or command buttons assigned to a particular IA match the IA and need not be the same for different information assets, as is the typical case with traditional information management systems. Step S212 assigns optional operations or command buttons to the IA. They include, for example, commands to send the IA to an optical character recognition (OCR) service that can be a separate service, IP, HTTP-based or an asynchronous operation. Alternatively, the optional operation can be another OCR operation that can perform OCR on a selected part of the IA, or on digital graphic portions or can involve multi-part associations. At step S213, the information asset is submitted to an indexing engine (asynchronous service) Again, this can be a separate service, IP, HTTP-based. This step can index all or selected fields of the IA, including but not limited to the IA summary, title, permissions, IA text, keywords, time, metadata, and content-type. At step S214 the SDO created as described above is submitted to a storage service. This can be a database that is a file reference with a pointer to the actual location of the IA on a network or a local file system, or it can be a database that contains the actual IA in a repository such as a user's computer or a centralized repository. The document object model so generated is made available for use in step S215.

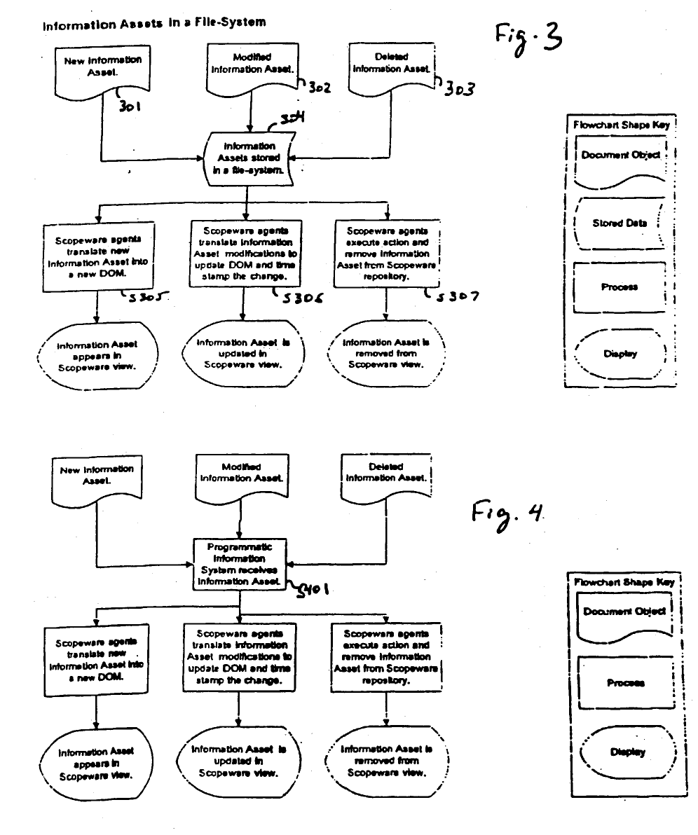

FIGS. 3 and 4 illustrate methods of creating document object models from information assets. As seen in FIG. 3, three type of information assets are involved in this example—new information assets 301, modified information assets 301, and deleted information assets 303. All come to a file system 304. At step S305, agents specific to the disclosed embodiment of the system known as Scopeware 2.2 translate the IA into an SDO, i.e., create an SDO shell for the IA, with attributes as discussed in connection with FIG. 2. At step S306, Scopeware agents translate the IA modifications into an updated SDO and time-stamp the change so the new time-stamp becomes a part of the SDO and the modified IA can be placed in the stream of documents at a place reflecting the new time-stamp. At step S307, Scopeware agents execute actions for removing the deleted IA from the repository of documents. The display, such as that seen in FIG. 1 reflects the actions takes at steps S305, S306 and S307. As a result of step S305, the stream on the display shows at 308 the new IA (provided the time period where the new IA fits is being displayed). As a result of step S306, the modified IA appears at 309 in its correct place in the displayed receding stream of documents. As a result of step S307, the deleted documents is removed at 310 from the displayed stream, and the remaining stream is now displayed.

In FIG. 4, a programmatic information system at step S401 receives new, modified and deleted information assets for storage and distribution to appropriate translation agents as illustrated. In other respects, the FIG. 4 arrangement corresponds to that of FIG. 3, so the description of corresponding portions will not be repeated.

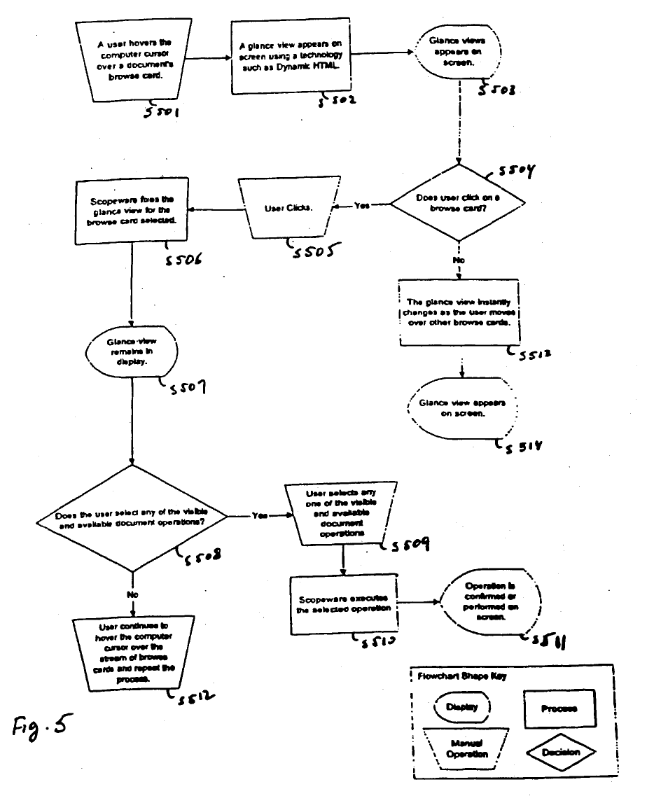

FIG. 5—Glance View:

At least some of the document object model created as described above becomes a part of a glance view or browse card of the type illustrated in FIG. 1. An important feature of the system disclosed here is to conveniently dispaly such a glance view in a natural and intuitively accepted way to facilitate operations.

Traditional user interfaces for computers typically present lists or graphical icons of “documents” (including but not limited to computer files, emails, web pages, images and other types of electronic information). These lists and icon displays provide only a limited amount of information about the document—typically, title and application type only, although they can provide additional information in some cases. This can make it difficult for users to identify the document without downloading and/or opening the document with its associated application. For example, in Windows 2000, the user interface can display a small temporary pop-up window of the document's title, application type, author and size when the user hovers his cursor on the document icon; however, the pop-up window appears only after a brief delay, sometimes a second of two, and is for documents that are on the screen at the time, which tend to be a small part of the many documents typically stored in or accessible through a user's computer. In contrast, the disclosed system creates a pop-up window for heterogeneous documents of known and unknown application types that appears essentially instantly, as perceived by the user, upon touching the document's representation in the user interface with the cursor or some other pointing device. In the example of FIG. 1, this representation is an “index card” in a cascading flow of overlapping index cards (also called “browse cards in some embodiments”), and the pop-up window is called a “glance view”. This glance view not only contains the document's title, application type and owner, but also may contain rich multimedia cues (such as a thumbnail image of the first page of the document, a WAV or MP3 preview of an audio file, or an animated GIF preview of a video file), text summaries and document operations specific to the document's application type and access permissions. For example, if the user has write-permission for a document, the “Edit” operation will be visible and available; however, if not, the Edit operation will not be visible or available. These document operations are interactive, allowing users to select available operations directly.

Referring to FIG. 5 for an illustration of the instantaneously dynamic, tailored, and interactive document glance view feature of the disclosed system, at S501 a user hovers his or her computer cursor over a document's browse card. Essentially instantly, at least as perceived by the user, and without any mouse clicking or other action on the part of the user, at step S502 the information needed for a glance view is generated, and at S503 the glance view appears next to or near the browse or index card, using a technology such as Dynamic HTML. If the user clicks on a document's browse card, as detected by the test at step S504, and as executed by the user at S505, step S506 causes the glance view to become fixed and step S507 causes it to remain in the display. The glance view does not change until the user clicks on another document's browse card. If the user does not click on any browse card, as determined by the test of step S504, the glance view will instantly change as the user moves his cursor over other browse cards, to reflect the glance view of the currently touched by the cursor browse card. If the user has clicked on a browse card to fix the glance view as a stationary window, the user can then select any of the visible and available document operations, by taking the “yes” branch of step S508 and selecting at S509 an available operation (as earlier described, the operations or command buttons that show are specific to the document or type of document). At step S510 the system executes the selected operation (command) and the display reflects this at S511. If at step S508 the user takes the “no” branch, she can continue to hover the cursor over the stream of browse cards and repeat the process, at step S512. If at S504 the system determines that the user has not clicked to fix a glance view, the glance view information essentially instantly changes at S513 as the user moves the cursor over other browse cards, and the new glance views appear on the screen at S514.

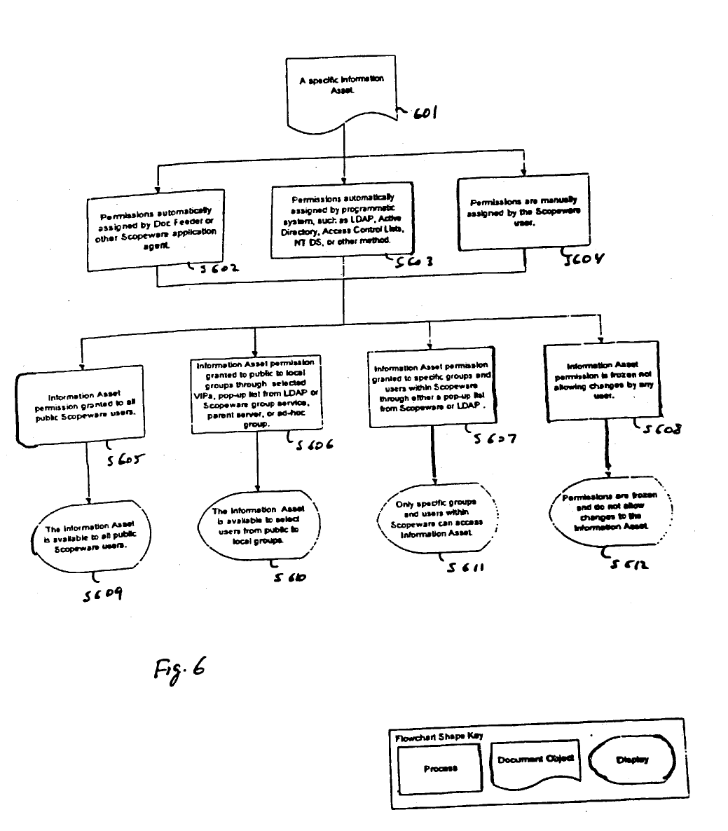

FIG. 6—Granular Access Permission:

FIG. 6 illustrates a process involving another important feature of the disclosed system—granular permissions for access to information assets that allows clients to receive seamless and uniform access to contents without necessitating changes to existing network security and access rights. In traditional systems, a network administrators typically would grant access to specific network drives and file folders. The permission typically would allow a user to access the entire folder or drive, or would deny access to an entire folder or drive, rather than to a particular information asset or document.

In the disclosed system, each information asset is accessible through specific access permission for each client or designated group of clients. Examples of access stage permissions are read, write, and aware. Read permissions allow a client to view the full information asset. Write permissions allow the client to view and edit the document. Aware permission alerts the client that an information asset exists, for example by providing a document shell in the client's stream of documents, but does not allow the client to view or edit the document. A group of clients who want to collaborate on a project or event can establish a designated group that can be assigned permissions to relevant documents for the project or event. Thus, each member can receive real-time additions to his or her stream of documents and information assets are posted. The clients can assign permission to the other group members themselves, by so designating the appropriate documents to be shared, without involving a network administrator. Some documents, such as personal to-do lists, can be accessible only to a specified user, but the user can change this at any time to allow access, full or partial, to other designated persons. Assignments of permissions for access can be done as granularly as an individual client level or individual document, or as diffuse as a departmental or enterprise level.

As seen in FIG. 6, an information asset 601 can have permission levels assigned to it in several ways. At step S602, a software agent such as Doc Feeder can automatically assign permissions; at step S603 a programmatic system such as SDAP, Active Directory, Access Control Lists, NT DS, of some other system assigns permissions to the document; and/or at step S604 the user manually assigns permissions to the document. Examples of processes relevant to different types of permissions are: step S605 grants access to all public users of the system; step S606 assigns permissions to groups as illustrated; step S607 assigns permissions to specific groups as illustrated, and step S608 freezes permissions and does not allow the document to be changed. The display, of the type illustrated in FIG. 1, can provide information representative of the permissions, as illustrated at steps S609 through S612 in FIG. 6.

FIG. 7—Integrating Search Results from Distributed Searches:

Another important feature of the disclosed system is illustrated in FIG. 7 and pertains to integrating search results from distributed searches. In traditional systems, search requests in a client/server model with a central index usually return a single, well-defined results set. In a peer-to-peer network, however, search results may come back to the “Source” computer (the computer that issues the search query) in a haphazard manner because of network latency (variable traffic speed and bandwidth across a distributed network) and variable peer presence (peer computers can be turned on and off, or removed from network at times).

The disclosed system asynchronous responses to a distributed query across a peer-to-peer network of computers integrate the results from diverse sources, arriving at different times, and comprising diverse types of documents, into a single unified results set. One preferred embodiment leverages the time-ordered presentation interface earlier described so that search results are integrated into a time-ordered stream according to each document's original time-stamp, regardless of when the document's search results set was received.

As seen in FIG. 7, at step 701 a user at a Source computer selects peer computers (“Peers”) across which the distributed search will be performed. If the test at S703 determines that there is no central registry with peer hookup, and the test at S704 determines there is no user-specified IP address of peers, the process returns to S701, where the user can specify addresses or they can be provided in some other way. The central registry with lookup of Peers can involve Online/offline status, IP/DNS resolution services and Optional public/private key authentication. When the test at S703 or at S704 leads to the “yes” branch, at step S705 the Source computer sends out a search request that travels to each selected Peer in the network. At S706, each Peer that receives the search request queries its index for documents that match the search criteria, and at S707 the peer computer then sends its results set back to the Source computer. The response can be XML-based, a binary byte stream, or an in-band and out-of-band transfer. At S708 the Source computer takes the results set from each Peer and builds a single collective results set. In a preferred embodiment, this collective results set is organized as a time-ordered stream of documents, as seen in FIG. 1. This can involves an on-the-fly browser combination with XML & XSL with time-sort algorithm, XML to presentation layer with time-sort algorithm, and in-band and out-of-band transfer. Importantly, at S709, the Source computer continues to expand this collective results set, essentially in real time as it receives additional results sets from Peers until all Peers have responded or some other relevant event has taken place. At S710, the collective results are displayed as soon as results have come in at the Source computer, and the display is updated as additional results come in, even when a Peer that was off-line comes on line and sends results at a later time.

FIG. 8—Tri-State Tree:

Yet another feature useful in one example of the disclosed system is a particularly convenient tri-state tree. In a scrolling tree directory of the contents of a hard drive (or hard drives in a network), a user may want to select “Parent Folders” (folders containing subfolders) and “Child Folders” (subfolders contained within a folder) that can be further operated on. The tri-state feature disclosed herein allows users to select folders in one or more of the following combinations:

1. All Parent Folders and all Child Folders

2. Some Parent Folders and all their Child Folders

3. Some Parent Folders and some of their Child Folders

4. No Parent Folders and no Child Folders (a do nothing option)

This selection tree has useful application beyond the particular example of information handling disclosed here; it can be used to select folders for any computer operation. For example, it can enable users to discretely select software application or operating system components to install or remove.

A single scrolling tree directory of Parent and Child Folders that can expand and contract to show the contents of Parent and Child Folders is known—Microsoft Windows Explorer is an example of one. A Tri-State Selection mechanism also is known—Microsoft Add/Remove Windows Components is an example of another way of selecting various Parent and Child Folders. However, the Microsoft Add/Remove Windows Components feature does not display all Parent and Child Folders within a single scrolling tree directory; Child Folder and other contents of a Parent Folder are displayed in a separate window only after the user clicks on a Details button. In addition, only the contents of one Parent Folder can be displayed at a time.

The Tri-State Selection Tree described here combines the elements of a single scrolling tree directory with a tri-state selection mechanism in a new and unique way to enable users to discretely select specific Parent and/or Child Folders all in one single view.

Referring to FIG. 8 for an illustration, at step S801 a user is first presented with a tree directory of the highest level of Parent Folders on a hard drive or network. At S802 the user can expand the tree directory to show Child Folders by clicking on a plus/minus sign next to each Parent Folder, and the directory so expands at S803. At S804, the display shows a check box next to each Parent Folder (e.g.; to the right of the plus/minus sign). By default, all check boxes are empty, indicating that no Parent or Child Folders are selected. If at step S805 the user clicks on a check box once, the process at step S806 selects the marked “/” Parent Folder but none of its Child Folders are selected, and step S807 shows this on the display. If at step S808 the user clicks the check box a second time, the slash mark is replaced by an “X” and all the Child Folders' check boxes are then selected and grayed out at S809, indicating that all Child Folders are selected for that Parent Folder, and this is displayed at S810.

Thus, by expanding the tree and clicking on check boxes, the user can systematically and efficiently select a discrete number of folders on which to perform an operation.

RAIS—Redundant Array of Inexpensive Servers:

Yet another feature useful in one example of the disclosed system is an arrangement of a redundant array of inexpensive servers (RAIS). Processing of a large set of information or documents requires benefits of a centralized architecture—reliability and scalability, and RAIS is a novel approach to provide benefits of a centralized architecture—namely reliability and scalability with numerous inexpensive computers. Thus, RAIS can deliver essentially infinite scalability, can allow inexpensive smaller computers to be used to solve enterprise computational problems cheaper/faster than expensive larger platforms.

For example, consider:

Set of Information, D, with specific documents D1, D2, D3; D{D1,D2,D3}

RAIS of N×N size, with N=3; RowN, CoIN

Replication factor is number of columns

Scalability factor is number of rows

1. Here N=3, with 9 computers

| | Col1 | Col2 | Col3 |
|---|---|---|---|
| Row1 | A | A | A |
| Row2 | B | B | B |
| Row3 | C | C | C |

2. To post a Document, Dn, one copy is sent to a sub-server in each CoIN, so

| | Col1 | Col2 | Col3 |
|---|---|---|---|
| Row1 | A(Dn) | A(Dn) | A(Dn) |
| Row2 | B | B | B |
| Row3 | C | C | C |

3. Thus Dn is replicated N times (N=3) and thus if Col1:Row1 computer is unavailable there are two other computers with the same Dn. This is RAIS replication.

4. To post a universe, or set of documents, D{D1,D2,D3}, can use simple (round-robin) or complex (latency, closest path, spanning tree) routing, sending each document to a different RowN.

| | Col1 | Col2 | Col3 |
|---|---|---|---|
| Row1 | A(D1) | A(D1) | A(D1) |
| Row2 | B(D2) | B(D2) | B(D2) |
| Row3 | C(D3) | C(D3) | C(D3) |

5. Thus to reassemble the entire universe or set of documents, D, requires sending a request to each RowN. To reconstruct, D, for an N×N RAIS requires N request/responses.

6. Multiple smaller requests can be used instead of one mammoth request. This reduces latency, bandwidth and process constraints. This is RAIS scalability.

7. Note that any one of the computers in Row1 can be used to re-construct the total set D found in Col1. For example, if Row1:Col1 computer is unavailable, then Row1:Col3 computer has a copy of the data. In fact, D can be reconstructed from any arrangement that completes a CoIN.

8. To increase either replication or scalability simply increase N.

Scopeware Software Agents, either desktops or servers, can be installed on each computer in a RAIS matrix to achieve this functionality.

FIGS. 9 and 10—Architectures, Including Bottom-Up and Top-Down:

The disclosed system can be implemented in a variety of ways in terms of physical information storage—for example, physical information storage can be centralized or decentralized. Decentralized storage, physical storage of information with multiple servers and/or clients, is possible through network agents called Doc Feeders, which may be located at a server or client level. The Doc Feeder allows a storage location of a client, for example a file folder on a desktop hard drive, to be included in the system level data repository for use throughout an organization or enterprise. Depending upon implementation, the Doc Feeders can replicate the document or information asset (IA) to a server or maintain a constant pointer to the physical storage location while populating the system with the standard document object model (SDO). As earlier described, an SDO is a document shell of the document or IA that contains, among other items, a thumbnail of the IA, permission rights, and metadata. An SDO is created from the IA and placed on a Scopeware server or client, either independent of the IA or with a replication of the IA. From there, the Scopeware server or client will share the SDO (with constant pointer to the IA or replicated IA) with other connected system servers and clients in order to make the IA available to all clients connected to the network. Thus, the system servers and network agents (Doc Feeders) act as document proxies for both storage and retrieval of IAs.

The system servers within the network need not be physically close or in proximity. For example, a client in a truly global organization with locations and system servers on several continents can query and retrieve sales results across all system servers and clients through a federated search. In essence, the disclosed system creates a virtual store from all documents accessible to any system server or client either centralized or decentralized.

The physical information storage of the disclosed system follows three models: duplication, replication, and document reference. The duplication model physically stores a duplicate IA on the parent Scopeware server that was created by the client. Other clients polling the parent Scopeware server have full access to the IA, depending upon permissions, whether or not the original document is available from its native storage location (i.e. client PC is turned off). The replication model replicates the IA from the parent Scopeware server to the peer Scopeware servers within a federated network. All clients within the federated network have full access to the IA, depending upon permissions, whether or not the original document is available from its native storage location (i.e. client PC is turned off). An example of the replication model is the concept of a redundant array of inexpensive servers. This concept, which is described in detail in the distributed enterprise model (also called bottom-up architecture), utilizes client machines in place of or in addition to servers. The document reference model “parks” only an SDO of the IA on all Scopeware servers and maintains a constant pointer to the actual physical location of the IA rather than storing a full copy of the IA on the Scopeware server. Other clients will only be able to gain access to the IA when the physical location of the IA is connected to the network (i.e. client PC is turned on).

Also as earlier discussed, two primary types of stream topology are Bottom-Up and Top-Down. Through the use of both Bottom-Up and Top-Down methodologies, Scopeware creates a living stream for the client with new SDOs appearing automatically as content arrives. The Scopeware distributed enterprise model can make use of both server-based resources and client-based resources where appropriate. Both types of streams can be used simultaneously and interchangeably.

Bottom-Up streams involve information collaboration formed by ad-hoc groups of Scopeware clients. A bottom-up stream is composed of information created by the clients of a transitory group. Information shared and created by this group is, or at least can be, replicated via point-to-point connections (e.g., from client PC to client PC or, as an alternative, through a server). In this way, bottom-up groups can form and disperse frequently, and without notification, while its members will still have access to the shared information. FIG. 9 illustrates this configuration.

Top-Down streams are more permanent, generally more administrative streams or collections of information, such as company-wide distribution lists, or groups like ‘Accounting’ and ‘Development’. In these groups, information is “parked” to the server from the desktop. The server then sends the information to other known servers. Each client maintains a polling connection to the server to retrieve “parked” documents that have recently arrived from other remote servers or from local clients. FIG. 10 illustrates this configuration.

As earlier described, the user interface within the Scopeware product portfolio has unique characteristics. The SDO provides certain information that allows quick perusal of the information retrieval results via a proprietary “browse card” similar to an index card that contains data on the underlying IA. A unique “browse card” is created for each IA. The “browse card” includes metadata for the document, which is comprised of a title, identification number unique to Scopeware document referencing, date/time stamp, and owner information. The “browse card” also presents a thumbnail image of the IA and a summary of the IA contents. Finally, the “browse card” contains a list of operations appropriate for the IA's application that include, but are not limited to, copy, forward, reply, view, and properties.

The “browse card” arrives in the stream of those clients that have permission to view the IA. The owner can grant access to other clients or groups by granting read, write, or aware permissions through the properties of the “browse card.” Permission can be granted on any granular basis, on individual-by individual or group basis from the SDO, or through predetermined administrative groups via the Scopeware server.

The displayed material typically is presented in a time-ordered sequence starting in the present going back into the past. The primary view is the stream, but other formats include a grid, Q-list, and thumbnails. The various views address the client's personal preferences for accessing time-ordered content in their most logical way. These views all contain the information presented in a “browse card” but are organized in a different method. Other specialized views include the address book and calendar.

An advantage of the “browse card” approach is the ease of browsing, searching, and retrieving IAs. In the stream view, the displayed representation of each IA are aligned much like cards in a recipe box. For each item, the title and application icon are viewable on the “browse card” in the stream. When the client passes the cursor over the “browse card” in the stream, the full “browse card” or a “glance view” is presented to the client for easy viewing. From the “glance view,” the client can perform any of the aforementioned actions available to the IA, subject to permission access.

The disclosed system is suitable for a number of computing models servicing multiple clients including a single departmental server model, an enterprise server model, a distributed enterprise model, and a peer-to-peer model (absent a dedicated Scopeware server or common server). In addition, the software enables wireless computing independent of or in conjunction with any or all of the aforementioned models. Wireless clients include WAP enabled phones, PDAs, Pocket PCs, and other similarly capable devices capable of receiving and transmitting data across a network. All of the Scopeware Implementation Models make use of components previously discussed, providing consistent interface available across different computing topologies, from monolithic single servers to peer-to-peer collaboration.

Access to the IA contained in the Scopeware repository can be achieved through two methods. The first method of access is through the thin-client method. The thin-client method utilizes a web browser, such as Microsoft's Internet Explorer or Netscape's Navigator, on the client device to gain access to the Scopeware repository residing on the Scopeware server. The second method of access is the desktop-client method. The desktop-client method involves a local installation of Scopeware on the client device. The client device is then capable of performing the storage, retrieval, extraction, and processing of IAs as they are introduced to the Scopeware repository. All the models below can utilize either method of access to the Scopeware repository, however the distributed enterprise and peer-to-peer models are optimized with the desktop-client method. Some examples of such models are discussed below.

Single Server Model. A single server model makes content on one Scopeware server available to any client connected to the departmental server. The Scopeware software creates a unique SDO that represents to the user interface the relevant details of the IA physically stored by the server or client. Thus, when a client connected to the network requests access to and retrieval of IAs through Scopeware, the client can view all documents contained within the network that satisfy the query parameters and access restrictions regardless of the document's native application. The documents available include those stored locally by the client, those saved to a central storage location, and those stored by peer clients with Doc Feeders connected to the shared server

Enterprise Server Model. In an enterprise server model, where multiple Scopeware servers are installed, federated access to and retrieval of IAs across the network is enabled. In federated information sharing, a client asks one Scopeware server for IAs that may reside on it or one of many connected peer Scopeware servers. In this model, the actual IA may reside on any network-connected client, the Scopeware server, or a centralized data storage location. Transparent to the client, the Scopeware servers shuffle the retrieval request and access restrictions to present a single, coherent stream to the client via the presentation architecture previously discussed (within the original patent document).

Distributed Enterprise Model. A distributed enterprise model utilizes the clients for storage, retrieval, and processing of IAs. Through the use of directory monitoring agents, similar to network agents, the physical location of an IA need not be on the Scopeware server, but rather can reside with any client. The Scopeware servers take on a secondary role as administration servers and content parking lots. This model pushes the processing tasks to the clients while using the servers to shuttle IAs throughout the enterprise. The indexing engine, thumbnailing engine, lightweight storage database will be based at the clients.

Taking Scopeware beyond distributed networking and the federated architecture—into a more distributed approach—can be straightforward, given the way that the system has been designed. Key elements of are distributed document processing and scalable server arrays.

Distributed document processing consists of two different approaches. First, when information was created physically on a desktop machine, but was part of a larger application and intended for storage on a server (rather than on the desktop), the Desktop facilities can do the document extraction, indexing, thumbnailing, etc., and post the results to a Scopeware Server. Second, a Scopeware Server that was handed a document (perhaps from an OCR process or from a central email application) can hand the document off to an available Scopeware Desktop for the same processing. These strategies relieve the processing load on the Scopeware Server and leave it free to focus on handling searches and stream integration, allowing a given Scopeware Server to handle a much larger user load.

When an organization needs to support central processing of large document bases—and needs the reliability, accessibility and security of a centralized architecture—Scopeware Servers can support deployment in the novel RAIS architecture—a redundant array of inexpensive servers. In this architecture, imagine a square array of desktop machines—call each one a “sub-server.” The array as a whole comprises a Scopeware Server. (This does not require wiring together an actual array or cluster; any interconnect such as a Ethernet sub-net or even HTTP over a broader network will work.) In these arrays, columns of servers provide redundancy for storage, while rows (within columns) provide redundant points of distribution.

To post document D, one copy of D is sent to a sub-server in each column of the array. To replicate everything five times such that losing any data requires the loss of five sub-servers, five columns are used. The number of columns in the array is managed to support exactly the degree of replication (and redundancy) desired. The write processes can be managed in a number of ways to ensure that the different rows in the columns are balanced.

To send a polling message or search request (“give me all the latest stuff”), a request is sent to each sub-server in one column (note that the means to do this transparently to the user is an extension of the federated search technology). Each column of sub-servers absorbs one copy of every posting (because any write has gone into at least one row of the column); therefore, all the sub-servers in any one column collectively have copies of everything. Just as a “replication factor,” is chosen for data redundancy, a “distribution factor” is chosen for responsiveness and for data management, representing the number of rows in any column. To get ten small responses to a search request instead of one big response, or to distribute the total data-storage burden over ten machines instead of one, the array is implemented with ten sub-servers in every column.

The entire “Server” can be run with only one row (resulting in replication, but no distribution) or with only one column (resulting in distribution but no replication). In the limit, row size=column size=1, and the effect is to have a single conventional server.

This approach to distributed processing, scalability and reliability for large applications allows arbitrary sets of “smaller” computers (single/dual processor, inexpensive memory and disk storage) to be used in place of very large, expensive machines. This allows the application platform to be designed to the reliability and access requirements of the particular application, and then scaled incrementally (by adding more small machines into the array) as the actual application grows in terms of users served or information managed.

Distributed document processing and server arrays will give Scopeware almost infinite scalability while maintaining compatibility with early solutions or architectures. In addition to adding greater reliability, this architecture will support very large information processing applications. This will allow enterprise-scale, top-down applications—inbound support/sales email handling, customer service or even IRS-scale tax document processing.

Distributed document processing (with Scopeware Desktop) can be combined with either a “conventional” (1 processor array) Scopeware Server or with a more powerful array. This will allow organizations to create departmental or workgroup level solutions that can grow into enterprise applications if necessary.

At the same time, the system will allow users themselves to create self-organizing applications based on their specific and current needs. Ad hoc teams can create collaborative spaces that cross organizational boundaries if necessary. These applications can leverage either Scopeware Desktops or departmental-level Scopeware Servers.

Because the system has the architecture and capacity to support any level of centralization or decentralization concurrently, applications and their platforms can be engineered centrally or grown organically, and they can be tailored to the needs of their users and the organization on an ongoing basis.

Peer-to-Peer Model. The peer-to-peer (P2P) model allows multiple clients to share IA directly without the use of a dedicated Scopeware server. The P2P model allows for pure ad hoc collaboration among Scopeware clients. For example, a client can share IA via the Internet with identified Scopeware clients that have permission to access IA from the client, and vice versa. This is similar to the distributed enterprise environment except the dedicated Scopeware server has been removed as a storage, retrieval, and connection mechanism. Instead, Scopeware clients will connect point-to-point with other Scopeware clients through a general network connection such as the Internet.

Using P2P, a client can create a virtual shared stream that looks as though it is stored on a server but is in fact stored only by many clients. Historically, all clients would need access to a shared file folder on a common server in order to share information. With Scopeware, clients can share information that is located on each other's device and are not restricted to a common server or single physical storage location. To illustrate, five clients of Scopeware want to create a shared virtual stream to support a project. They call their group “Team One.” Then, when any member of “Team One” posts a document to his or her stream, and marks it “readable by Team One,” the system automatically sends a copy to every Scopeware client on the “Team One” list. Each Scopeware client receiving this document pops it into its client's local stream. Thus information created by a client who is a member of “Team One” (and flagged for Team One by the owner) winds up in the local stream of every member of Team One, whether the post is a document, an event (team meeting), task, or contact. It's as if he had sent his posting to a “client” server, and then everyone had polled the server, but in fact there's no server.

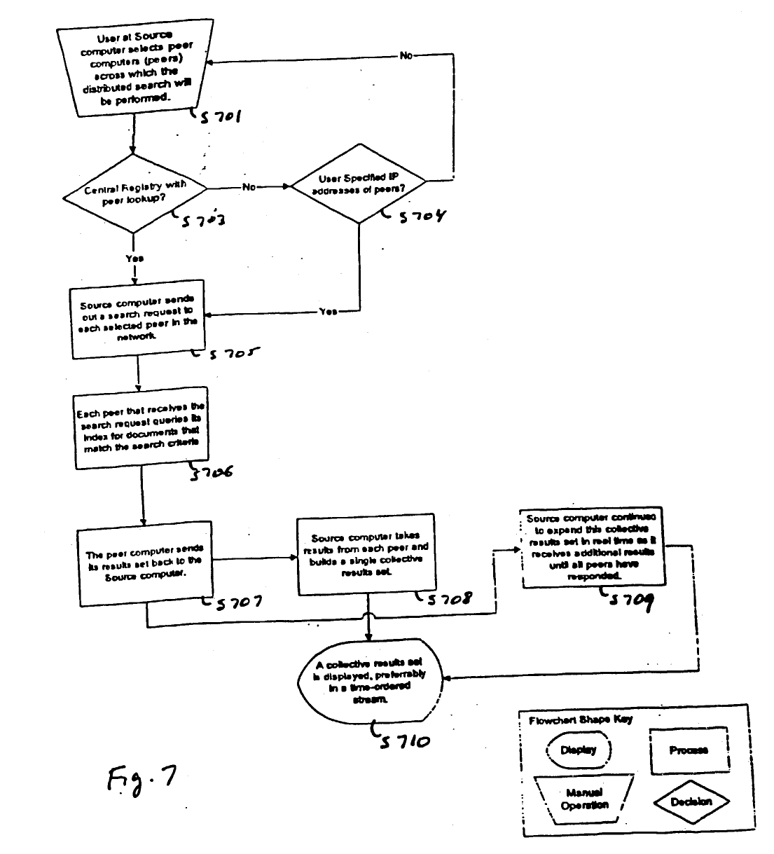

FIGS. 11-30—Wireless Appliance Functionality:

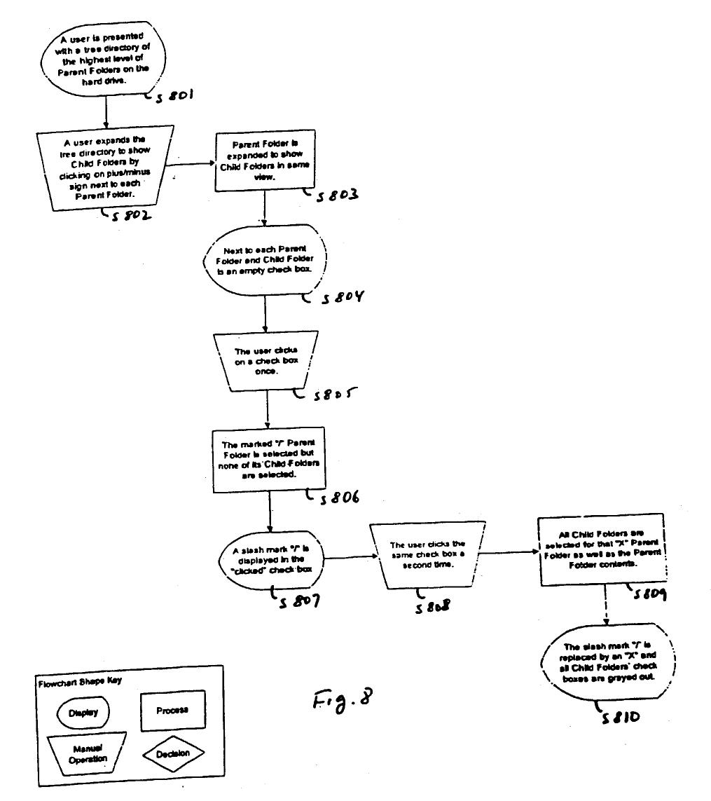

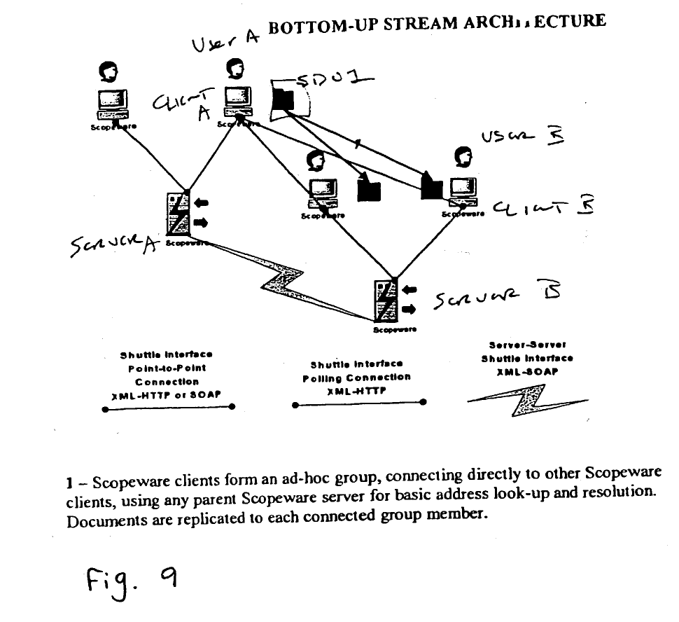

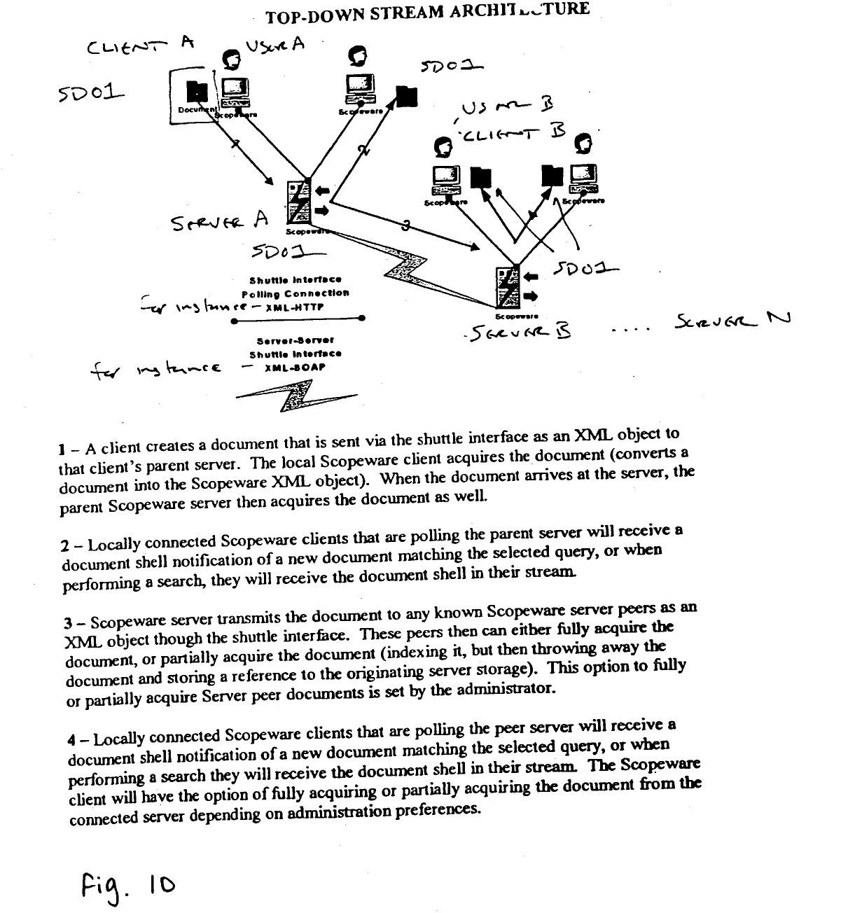

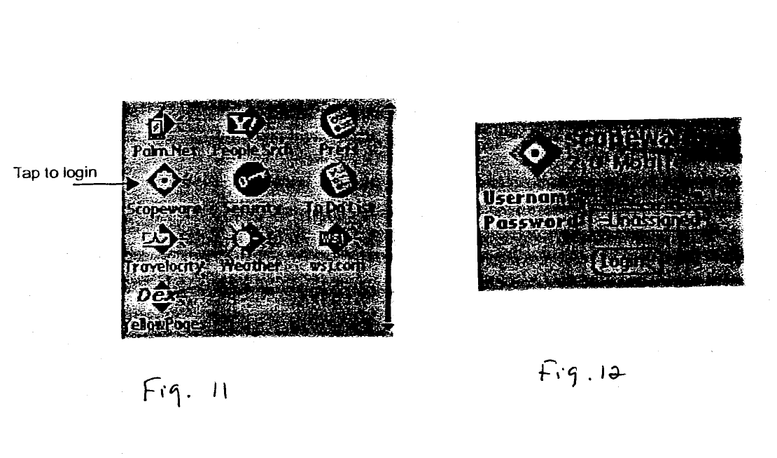

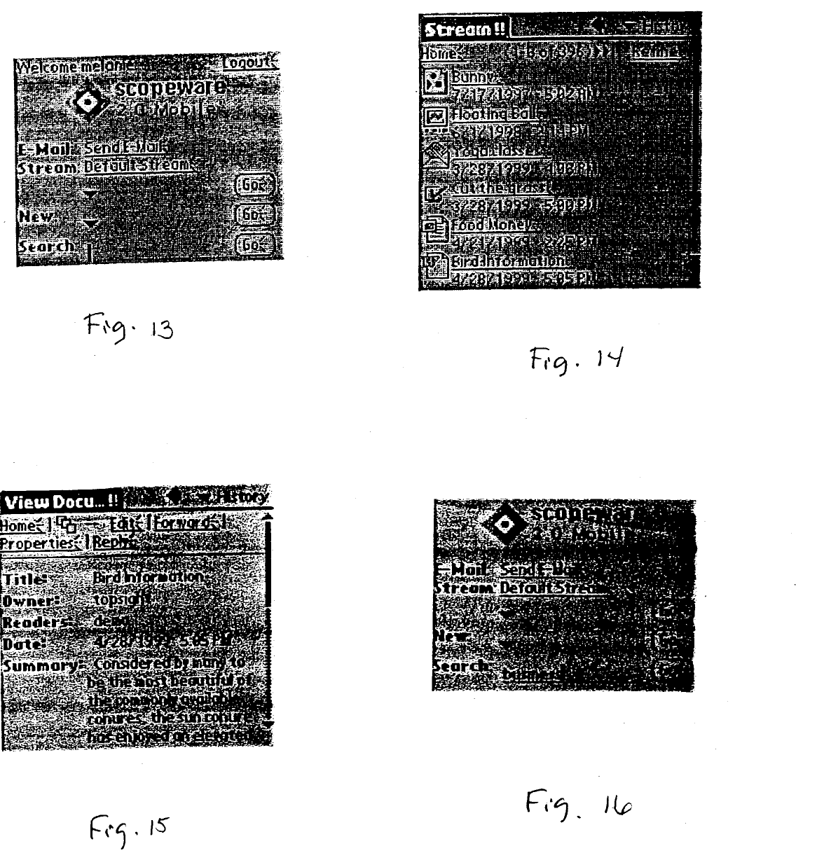

FIG. 11 illustrates the screen of an Internet-enabled wireless device, in this case a Palm VII PDA with wireless capability and modem such as a Novatel Minstrel and Palm clipping support, and subscribing to a service such as OmniSky for devices using wireless modem or PalmNet for Palm VII. Alternatively, the wireless device can be a 3G, WAP capable cell phone subscribing to a service with WAP support. The screen in FIG. 11 has, in addition to other common features, an icon labeled Scopeware, which the user can tap to access the relevant server. The server sends a login screen, displayed at the PDA as illustrated in FIG. 12 and, after the user enters the requested information, the welcome screen illustrated in FIG. 13 appears. As seen in FIG. 13, the user has a number of choices—to send email, to request the default screen unique to that used, to request a search, etc. If the user taps on the “Default Stream” in the welcome screen, the server responds by transmitting the requested information that appears on the PDA as the screen seen in FIG. 14. In this example, and in view of the display limitations of the PDA, the screen shows information on only a few of the documents in the default stream, and the displayed information is a contracted version of the document stream, appropriate for the display capabilities of the device or the user preference. For example, for the last document the screen shows a glyph indicating that the document is a Word document, a brief description “Bird information,” and the date and time of creation, receipt or revision of the document. Document operations or commands appear at the top of the screen. If the user taps on the last document in the screen of FIG. 14, the server responds by sending information such as for the display seen in FIG. 15, Again, this is not the full document, but is more information about and from the document than in the FIG. 14 screen. Importantly, the document operations or command at the top of this screen are different and unique to the nature of the document and to the nature of the wireless device (PDA in this case). The commands in this case include “edit” and forward.” The user can tap on the command shows as a left arrow button to return to the document list (FIG. 14) or the command “home” to return to the welcome screen (FIG. 13). Assuming the user returned to the welcome screen and tapped the “search” command there, a screed such as in FIG. 16 appears, where the user enters the search word “business” in this example and taps on the “go” button to the right. In response, the server carries out the search and sends the results, which show up on the PDA screen such as illustrated in FIG. 17, again in a form geared to the nature of the document (search results) and the PDA device limitations. Note that in this case the document operations (commands) for the document(s) of FIG. 17 differ from those for the document(s) of FIG. 15, as they are unique to the nature of the document(s) requested by the wireless device and transmitted thereto from the server. The user can tap on the “refine” command in the FIG. 17 screen and enter another search word to refine the search and likely reduce the number of responsive documents. Other paths can be followed in similar manner in response to different user selections in the relevant screens.

A particularly useful path is to select the “My Streams” option from the welcome screen (FIG. 13) by tapping on the down arrow until the screen illustrated in FIG. 18 appears. This screen gives a choice of substreams unique to the user, including in this example those having just the user's email, or only Word documents, or all documents created within the last hour, or all events (such as appointments), etc. If the user selects, for example, “my 3-day window,” and the results cannot all fit on the screen at the same time, the screen can display a rolling window that the user can scroll up and down. For example, the user can select the information line related to the current time to show in the middle of the window, with the information for the immediately preceding time on the several lines above and the information for the immediately succeeding time (e.g. appointments) on the several lines below.

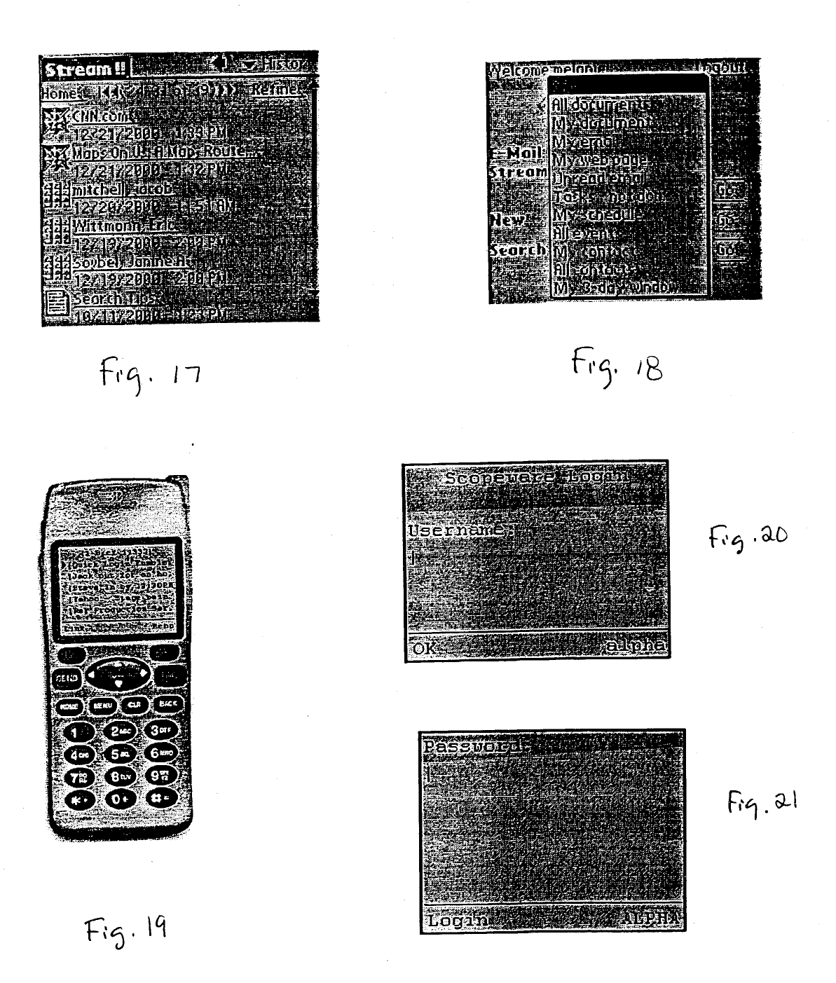

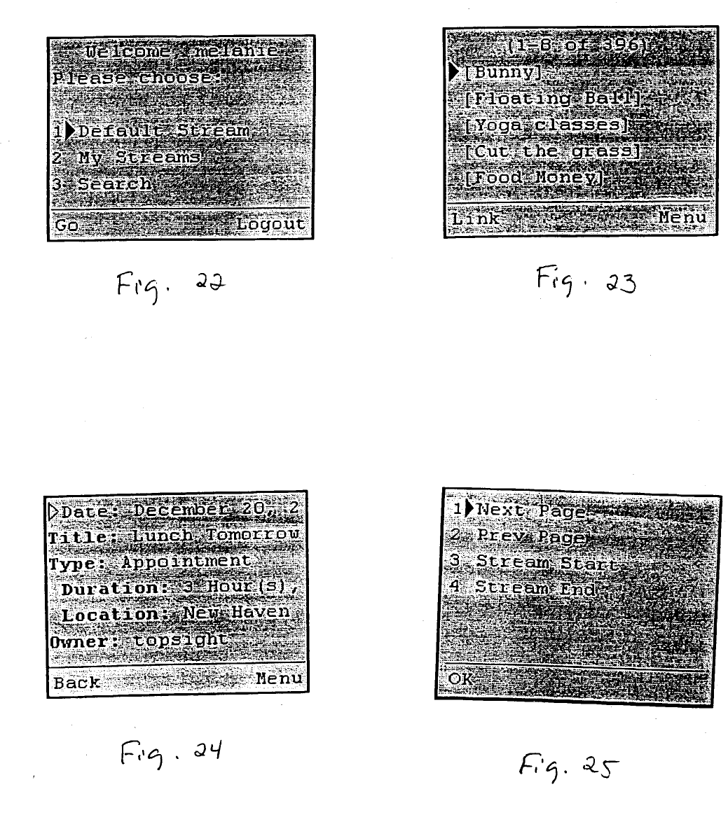

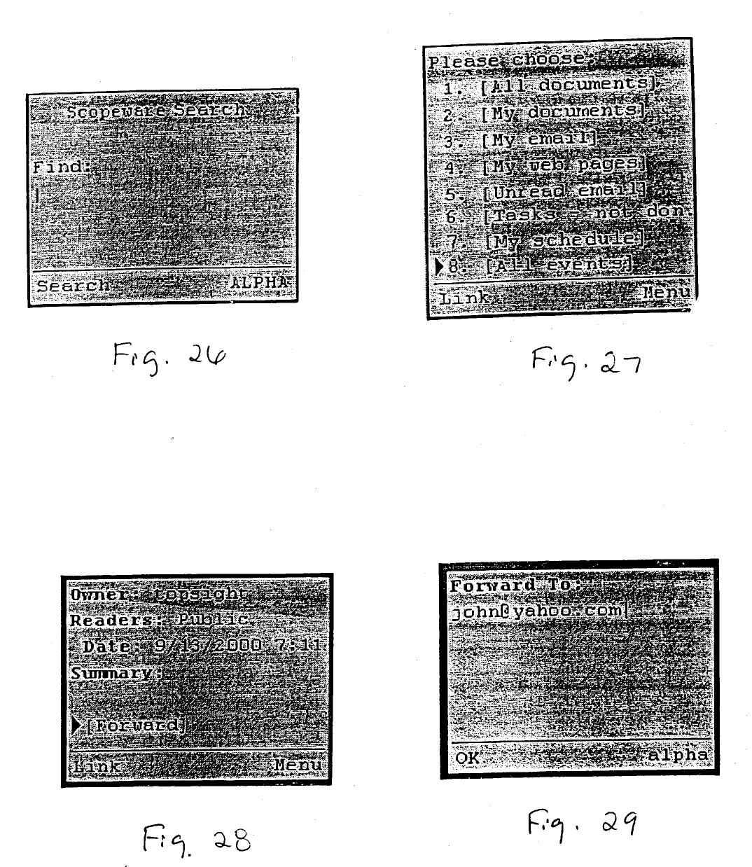

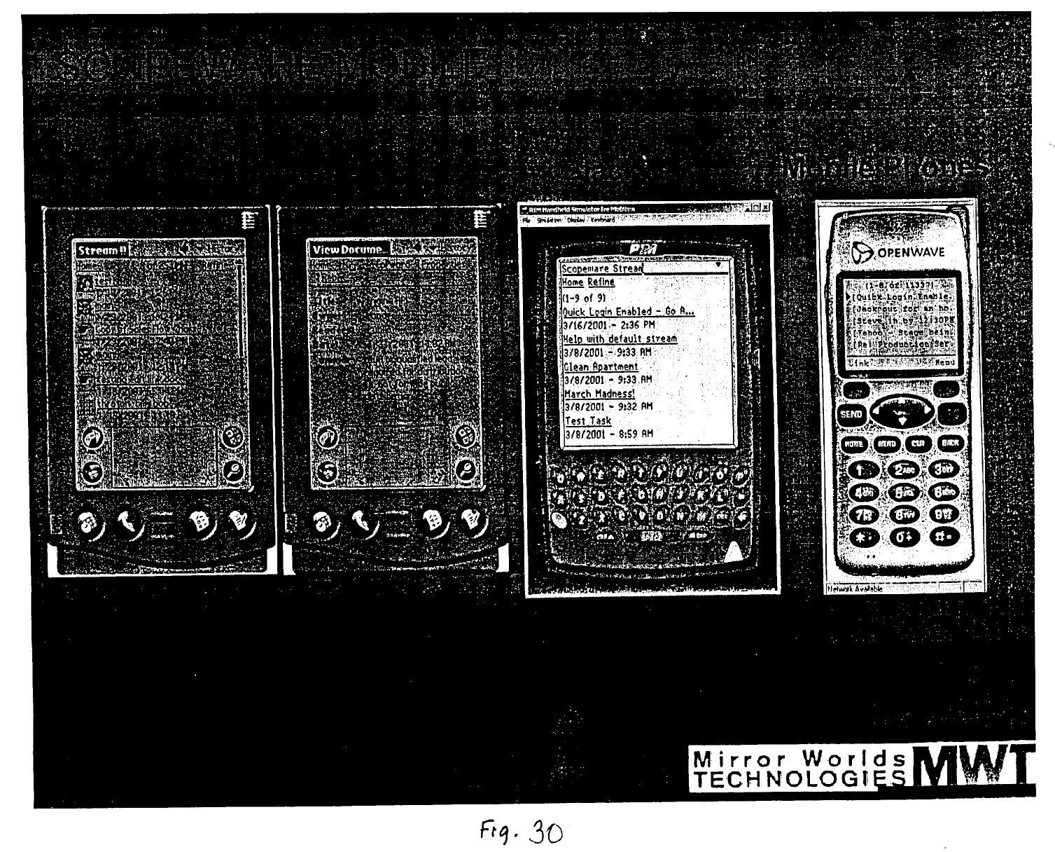

A WAP-capable cell phone can be used similarly in conjunction with a server through a cellular service with WAP support, taking into account the limitations of a cell phone that may differ from those of a PDA. For example, the cell phone may have an even smaller screen, different Internet browser capabilities, etc. After the user enters the url for the Scopeware server, the server transmits the information that the phone displays on a Login screen such as illustrated in FIG. 19, where the user enters the username, selects OK, then receives other screens, illustrated in FIGS. 20 and 21, for entering a username and a password, all through the input/output devices the cell phone has (the dialing keys). After successful login, a welcome screen such as illustrated in FIG. 22 appears and, if the user selects the “default stream” option, a screen such as in FIG. 23 appears. Note that in this example the information about the documents in the screen of FIG. 23 is even more contracted or truncated than in the PDA case (FIG. 14), in view of the smaller screen of this example of a cell phone. If the user selects the document “Bunny” in the FIG. 23 screen and clicks on the “Link” operation, a screen such as in FIG. 24 appears. Note that the options at the bottom of the screen depend on the nature of the screens—compare FIGS. 23 and 24. The user can navigate through streams of documents through commands such as illustrated in FIG. 25, and can initiate a search from the main screen that leads to a screen such as in FIG. 26. As in the case of the PDA example, the user of a cell phone can select the “My streams” option, in response to which the server sends a screen such as in FIG. 27. If the user wishes to execute a document command, for example to forward a document such as the one shown in FIG. 28, the user selects the “Forward” link, enters an address as in FIG. 29, and clicks the OK button. While only one document operation (command) is illustrated in the cell phone example, the command “forward,” other commands can be used as well, unique to the nature of the document, as discussed in connection with the PDA example.

As earlier discussed, a document or information Asset (IA) can be any digital or electronic item of information (such as and not limited to e-mail, office applications (Word, Excel, PowerPoint, PDF, etc.), audio files (WAV, MP3), video files, voice-mails, graphics (bitmap, GIF, etc), multimedia files (MPEG, JPEC, AVI), events, contacts, memos, voice-channels or communications, web pages, etc) that can be viewed, stored or created with a computer or another device and with which a user will interact. The documents and/or their SDOs are organized (logically if not physically) in time-ordered streams and sub-streams. The system puts every document or IA in the same type of meta-wrapper, regardless of content-type, application, size, etc., thus homogenizing disparate data. This standard framework can include full-text indexing, indexing all meta-information and embedded text for quick retrieval via searching, the automatic (or user specified) preparation of a text summary for quick reference, the thumbnailing of the IA for quick visual reference, the creation of multiple associated properties such as time created, time modified, time viewed, owner, readers, writers, etc., and the storage of this IA relative to one or more other IAs based on time-order, content-type, application-type. Whereas documents or IAs can be disparate and different and can often share nothing in common, all SDOs share common fields, properties and characteristics and thus can be shared, referenced, stored and manipulated without concern to the particular nature of the underlying IA. This technology provides a unifying scheme for IAs with coherent user access and presentation.

FIG. 30 illustrates Palm PDA wireless devices, a Blackberry PDA wireless, and a cell (mobile) phone set that are examples of units useful in practicing the systems and method disclosed in this patent specification. The screen displays in FIG. 30 are illustrative of operations performed in the course of using the disclosed system and method.

While various specific examples have been described above, it should be clear that they are only examples and that the scope of protection extends beyond them and is limited only in accordance with the appended claims.

1. An enterprise, top-down system for stream information management and organization, comprising:
a number of client applications operating on end-user computing devices, and a number of server applications operating on one or more servers;
each of said client applications being configured to selectively communicate at least with one of said server applications, and each of said server applications being configured to selectively communicate at least with another one of said server applications and some of said client applications;
each of said server application providing at least:
directory information regarding at least another one of said server applications, some of said client applications, some of said end-user computing devices, and other enterprise resources;
stream object routers selectively collecting, sending and storing stream document objects at least to another one of said server applications, some of said client applications, and some of said other enterprise resources; and
stream document object presentation and interaction, including display and action upon streams of stream document objects;
each of said client application providing:
stream document object routers collecting, sending and storing stream documents objects to at least one of said server applications; and
stream document object presentation and interaction, including display and action upon stream document objects;
said stream document objects comprising meta-document wrappers conforming to a standard stream document model causing documents that have different formats to appear similar and behave in similar fashion in said system, said meta-document wrappers being applied to diverse documents including static information documents, dynamic documents the contents of which change with time, documents generated by different applications, and documents that incorporate information of different modalities;
wherein said server applications and client applications are each configured to selectively send to and store selected stream document objects to any or all of said servers and any or all of said end-user devices currently communicating through said server applications;
wherein said server applications are responsible for distributing said stream document objects to said client applications; and
wherein said server applications and client applications selectively enable a display of selected stream document objects as receding and partly overlapping streams of time ordered objects.

2. An enterprise, top-down system for stream information management and organization, comprising:
a number of client applications operating on end-user computing devices, and one or more server applications operating on one or more servers;
each of said client applications being configured to selectively communicate at least with one of said server applications, and each of said server applications being configured to selectively communicate at least with some of said client applications;
each of said one or more server application providing at least:
directory information regarding at least some of said client applications, said end-user computing devices, and other enterprise resources;
stream object routers selectively collecting, sending and storing stream document objects at least to said one or more server applications, some of said client applications, and some of said other enterprise resources; and
stream document object presentation and interaction, including display and action upon streams of stream document objects;
each client application providing:
stream document object routers collecting, sending and storing stream documents objects to at least some other ones of said client applications; and
stream document object presentation and interaction, including display and action upon stream document objects;
said stream document objects comprising meta-document wrappers conforming to a standard stream document model causing documents that have different formats to appear similar and behave in similar fashion in said system, said meta-document wrappers being applied to diverse documents including static information documents, dynamic documents the contents of which change with time, documents generated by different applications, and documents that incorporate information of different modalities;
wherein said client applications and said one or more server applications are each configured to selectively send to and store selected stream document objects to any or all of said one or more servers and said end-user devices currently communicating through said server applications;
wherein said one or more server applications are responsible for assisting said client applications to distribute said stream document objects but said client applications are responsible for distributing the stream document objects to other ones of said client applications, directly or through said one or more servers; and
wherein said server applications and client applications selectively enable a display of selected stream document objects as receding and partly overlapping streams of time ordered objects.

3. An enterprise system for stream information management and organization, comprising:
a number of client applications configured to operate on end-user computing devices;
one or more server applications configured to operated on one or more servers;
said server applications being configured to selectively communicate at least with any other ones of said one or more server applications and with selected ones of said client applications;
each of said server applications providing:
directory information regarding at least any other ones of said one or more server applications, at least some of said client applications, and at least some other enterprise resources;
stream object routers selectively collecting, sending and storing stream document objects at least to any other ones of said one or more server applications, some of said client applications, and at least some of said other enterprise resources; and
stream document object presentation and interaction, including display and action upon streams of stream document objects;
each of said client applications providing:
stream document object routers collecting, sending and storing stream documents objects at least to one of said server applications and some of said client applications; and
stream document object presentation and interaction, including display and action upon stream document objects;
said stream document objects comprising meta-document wrappers that have a standard stream document model causing objects of different characteristics to appear similar and behave in similar fashion in said system, said meta-document wrappers being applied to diverse objects including static information objects, dynamic information objects the contents of which change with time, objects that contain information generated by different applications, and objects that incorporate information of different modalities;
wherein said server applications and client applications are each configured to selectively send to and store selected stream document objects to any or all of said servers and end-user devices currently communicating through said server applications; and
said server applications and client applications selectively causing display of selected stream document objects as receding and partly overlapping streams of time ordered objects.

4. A system as in claim 3 including:
at least one display facility displaying selected ones of said stream document objects as a receding, foreshortened stack of partly overlapping representations of respective ones of said objects such that only a part of each displayed representation, after the first one in the stream, is visible to the user;
said display facility further displaying a cursor or pointer and responding to touching a displayed representation with said cursor to essentially instantaneously display a glance view of the object corresponding to the touched representation.

5. A system as in claim 4 in which said glance view comprises an abbreviated version of the respective document object.

6. A system as in claim 5 in which said glance view comprises initial non-trivial words of the corresponding document object.

7. A system as in claim 5 in which said display of a glance view comprises selected important words, pictures, and/or sounds of the corresponding document object.

8. A system as in claim 3 including a document organizing facility receiving documents from diverse applications in diverse formats specific to the respective applications, automatically associating selected indicators with the received documents, automatically archiving the documents and indicators in consistent format for selective retrieval, and automatically creating information specifying respective glance views of said documents and respective document representations of said documents.

9. A system as in claim 8 in which said selected indicators are time-based.

10. A system as in claim 3 in which each of said stream document objects includes respective indicia controlling access permission to the respective individual stream document object.

11. A system as in claim 3 in which said stream object routers include facilities for responding to search requests for stream document objects by automatically integrating, into a single unified set, search results from diverse sources arriving at different times and comprising diverse types of stream document objects.

12. A system as in claim 3 including facilities for displaying a scrolling tree directory of parent and child folders and responding to user inputs to carry out a tri-state selection that selects one or more of the parent folders and all child folders, selected ones of the parent folders and selected ones of the child folders, and some parent folders and all their child folders.

13. A system as in claim 3 wherein at least some of said server applications and said client applications reside on a redundant array of inexpensive servers functionally configured in rows and columns, wherein any one steam document object is stored in all inexpensive servers of a respective row but not necessarily in other rows.

14. A system as in claim 3 in which at least some of said server applications store complete stream document objects while others store abbreviated versions of said stream document objects.

15. A system as in claim 3 in which at least some of said client applications communicate with said server applications wirelessly.

16. An enterprise method of stream information management and organization, comprising:
providing client applications configured to operate on end-user computing devices, and server applications configured to operated on servers;
each of said server applications being configured to selectively communicate with selected ones of said client applications and server applications;
each of said server applications providing:
directory information regarding selected ones of said server applications and client applications, and other enterprise resources;
stream object routers selectively collecting, sending and storing stream document objects to at least selected ones of said client applications, server applications, and other enterprise resources; and
stream document object presentation and interaction, including display and action upon streams of stream document objects;
each of said client application providing:
stream document object routers collecting, sending and storing stream documents objects at least to selected one or more of said server applications; and
stream document object presentation and interaction, including display and action upon stream document objects;
said stream document objects comprising meta-document wrappers conforming to a standard stream document model causing objects of different characteristics to appear similar and behave in similar fashion in said system, said meta-document wrappers being applied to diverse objects including static information objects, dynamic information objects the contents of which change with time, objects that contain information generated by different applications, and objects that incorporate information of different modalities;
wherein said server applications and client applications are configured to selectively send to and store selected stream document objects to any or all servers and end-user devices currently communicating through said server applications; and
said server applications and client applications selectively cause display of selected stream document objects as receding and partly overlapping streams of time ordered objects.

17. A method as in claim 16 including:
displaying said selected stream document objects as a receding, foreshortened stack of partly overlapping representations of selected ones of said objects such that only a part of each displayed representation, after the first one in the stream, is visible to the user; and
further displaying a cursor or pointer and responding to touching a displayed representation with said cursor to essentially instantaneously display a glance view of the object corresponding to the touched representation.

18. A methods in claim 17 in which said glance view comprises an abbreviated version of the respective document object.

19. A method as in claim 17 in which said glance view comprises selected initial non-trivial words of the corresponding document object.

20. A method as in claim 17 in which said glance view comprises selected important words, pictures, and/or sounds of the corresponding document object.

21. An enterprise method of stream information management and organization, said method including wireless access of end-user devices, comprising:
providing client applications configured to operate on end-user computing devices including wireless devices, and server applications configured to operated on servers;
each of said server applications being configured to selectively communicate with selected ones of said client applications and server applications, including wireless communications with selected ones of said client applications;
each of said server applications providing:
directory information regarding selected ones of said server applications and client applications, and other enterprise resources;
stream object routers selectively collecting, sending and storing stream document objects to at least selected ones of said client applications, server applications, and other enterprise resources; and
stream document object presentation and interaction, including display and action upon streams of stream document objects;
each of said client application providing:
stream document object routers collecting, sending and storing stream documents objects at least to selected one or more of said server applications; and
stream document object presentation and interaction, including display and action upon stream document objects;
said stream document objects comprising meta-document wrappers conforming to a standard stream document model causing objects of different characteristics to appear similar and behave in similar fashion in said system, said meta-document wrappers being applied to diverse objects including static information objects, dynamic information objects the contents of which change with time, objects that contain information generated by different applications, and objects that incorporate information of different modalities;
wherein said server applications and client applications are configured to selectively send to and store selected stream document objects to any or all servers and end-user devices currently communicating through said server applications; and
wherein said server applications and client applications selectively cause display of streams of stream document objects at said end-user devices and selectively vary the content of the streams depending on the types of end-user devices, said display selectively comprising receding and partly overlapping streams of time ordered objects for some end-user devices but being contracted for other end-user devices to contracted forms including a scrolling listing of the objects.
